(19) United States
(12) Patent Application Publication
(10) Pub. No.: US 2013/0291750 A1
(43) Pub. Date: Nov. 7, 2013

(54) REGISTRATION METHOD AND APPARATUS FOR PRINTING PRESS

(71) Applicant: Masahiro Hirano, Ibaraki (JP)

(72) Inventor: Masahiro Hirano, Ibaraki (JP)

(73) Assignee: KOMORI CORPORATION, Tokyo (JP)

(21) Appl. No.: 13/875,222

(22) Filed: May 1, 2013

(30) Foreign Application Priority Data
May 2, 2012 (JP) 105388/2012

(51) Int. Cl. B41F 27/00

(52) U.S. Cl. CPC B41F 27/005
USPC 101/481; 101/485

(57) ABSTRACT

This invention discloses a registration method for a printing press. The method includes the steps of storing the conditions of a sheet, and the position of at least one of a plurality of plate cylinders at the time of final printing in a storage unit in association with each other. The plurality of plate cylinders are configured to print images of different colors. The method also includes the steps of, in printing on a sheet to be printed, searching the information stored in the storage unit for a sheet with conditions, at least some of which are common to those of the sheet to be printed, and moving at least one plate cylinder to the position associated with the found conditions of the sheet. A registration apparatus for a printing press is also disclosed.

### BACKGROUND OF THE INVENTION

The present invention relates to a registration method and apparatus for overlaying the positions of images of a plurality of colors printed by a printing press.

In recent years, in registration for overlaying the positions of images of a plurality of colors printed by a printing press, the position accuracy of the image of each color in a printing plate, and the mechanical position accuracy with which printing plates are supplied and mounted on plate cylinders are improving by, for example, a CTP (Computer To Plate) which directly prints images on the printing plates from the electronic data of the images, and an APC (Automatic Plate Changer) which automatically supplies the printing plates onto the plate cylinders. It is therefore becoming unnecessary to print images of a plurality of colors on a printing sheet before the start of final printing, and perform registration in which the positions of plate cylinders on which printing plates are mounted to overlay the positions of the images of the respective colors.

Unfortunately, as a practical problem, every time an image of each color is printed, a printing sheet is supplied with dampening water and applied with a given pressure, and thus stretches gradually. This causes a misregistration between an image of a color printed first, and images of colors printed subsequently. As a result, when an end customer (a customer who sends a print order to a printing company, or a common customer who purchases a printing product) looks at a printing product, he or she may experience an impression that a misregistration has occurred locally strongly. To make the misregistration inconspicuous, the operator of the printing press performs a process of distributing it in respective directions (vertical and horizontal directions) as uniformly as possible. Therefore, the operator performs test printing more than once while adjusting the positions of the plate cylinders, and visually checks the completed printing product.

However, to make the misregistration inconspicuous, the operator must repeat a series of operations of adjusting the positions of the plate cylinders, performing test printing, and then visually checking the printing product. This series of operations requires a lot of time and effort, and therefore imposes a very heavy burden on the operator. This also poses problems associated with a decrease in operating ratio of the printing press, and waste of printing materials.

### SUMMARY OF THE INVENTION

In view of this, it is an object of the present invention to relieve the operator's burden in plate registration in a printing press.

In order to achieve the above-mentioned object, according to an aspect of the present invention, there is provided a registration method for a printing press, comprising the steps of storing conditions of a sheet, and a position of at least one plate cylinder of a plurality of plate cylinders at a time of final printing in a storage unit in association with each other, the plurality of plate cylinders being configured to print images of different colors, in printing on a sheet to be printed, searching the information stored in the storage unit for a sheet with conditions, at least some of which are common to conditions of the sheet to be printed, and moving the at least one plate cylinder to the position associated with the found conditions of the sheet.

According to another aspect of the present invention, there is provided a registration apparatus for a printing press, comprising a storage unit which stores conditions of a sheet, and a position of at least one plate cylinder of a plurality of plate cylinders at a time of final printing, the plurality of plate cylinders being configured to print images of different colors, a search unit which, in printing on a sheet to be printed, searches the information stored in the storage unit for a sheet with conditions, at least some of which are common to conditions of the sheet to be printed, and a movement control unit which controls to move the at least one plate cylinder to the position stored in the storage unit in association with the found conditions of the sheet.

### BRIEF DESCRIPTION OF THE DRAWINGS

FIG. 1 is a view schematically showing the arrangement of a printing system equipped with a plate registration preset apparatus used to practice a registration method according to the first embodiment of the present invention;

FIG. 2 is a view for explaining plate cylinder position adjusting motors;

FIG. 3 is a block diagram showing the arrangement of a plate registration preset apparatus used in the first embodiment;

FIGS. 4A and 4B are block diagrams showing the configuration of a memory shown in FIG. 3;

FIG. 5 is a block diagram showing the arrangement of each plate cylinder position adjusting device;

FIG. 6 is a flowchart showing the schematic operation of the plate registration preset apparatus shown in FIG. 3;

FIGS. 7A to 7H are flowcharts showing the detailed operations of the plate registration preset apparatus shown in FIG. 3;

FIGS. 8A and 8B are flowcharts showing the operations of the plate cylinder position adjusting device;

FIG. 9 is a view schematically showing the arrangement of a printing system equipped with a plate registration preset apparatus used to practice a registration method according to the second embodiment of the present invention;

FIG. 10 is a block diagram showing the arrangement of a plate registration preset apparatus used in the second embodiment;

FIG. 11 is a block diagram showing the configuration of a memory shown in FIG. 10;

FIG. 12 is a flowchart showing the schematic operation of the plate registration preset apparatus shown in FIG. 10;

FIGS. 13A to 13H are flowcharts showing the operations of the plate registration preset apparatus shown in FIG. 10;

FIG. 14 is a block diagram showing the arrangement of another plate registration preset apparatus; and

FIG. 15 is a block diagram showing the arrangement of a preset position calculation unit shown in FIG. 14.

### DESCRIPTION OF THE PREFERRED EMBODIMENTS

### 1. First Embodiment

The first embodiment of the present invention will be described.

### 1.1 Arrangement of Printing System

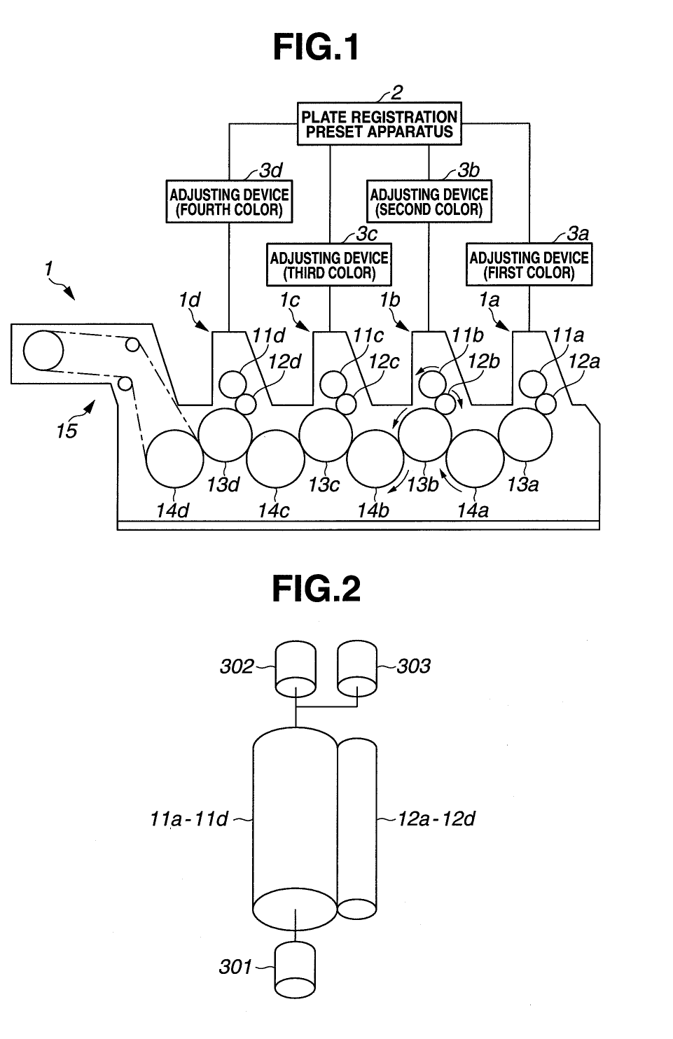

A printing system shown in FIG. 1 includes a printing press 1, a plate registration preset apparatus 2 which stores the positions of plate cylinders 11a to 11d of the printing press 1, and outputs these positions as needed, and plate cylinder position adjusting devices 3a to 3d of first to fourth colors, which adjust the positions of the plate cylinders 11a to 11d, respectively, of the printing press 1.

### 1.1.1 Arrangement of Printing Press

The printing press 1 is implemented by a known offset printing press, and includes printing units 1a to 1d of the first to fourth colors, as shown in FIG. 1. The printing unit 1a of the first color includes the plate cylinder 11a, a blanket cylinder 12a opposed to the plate cylinder 11a, and an impression cylinder 13a opposed to the blanket cylinder 12a. The plate cylinder 11a supports a printing plate on which an image is printed. The plate cylinder 11a is supplied with ink from an ink fountain (not shown). The blanket cylinder 12a receives the ink supplied to the plate cylinder 11a, and transfers it onto a printing sheet flowing between the blanket cylinder 12a and the impression cylinder 13a. The printing units 1b to 1d of the second to fourth colors also include the plate cylinders 11b to 11d, blanket cylinders 12b to 12d, and impression cylinders 13b to 13d, respectively.

The printing units 1a to 1d of the first to fourth colors are connected to transfer cylinders 14a to 14c interposed between adjacent units. That is, the transfer cylinder 14a is opposed to both the impression cylinder 13a of the printing unit 1a of the first color, and the impression cylinder 13b of the printing unit 1b of the second color. Similarly, the transfer cylinder 14b is opposed to both the impression cylinders 13b and 13c, while the transfer cylinder 14c is opposed to both the impression cylinders 13c and 13d. The printing unit 1d is connected to a delivery unit 15 by the transfer cylinder 14d. With this arrangement, a printing sheet on which an image of one color is printed by the printing unit 1a of the first color is printed with an image of each color while being sequentially fed to the printing units 1b to 1d of the second to fourth colors, reaches the delivery unit 15 while the images of the first to four colors are finally printed on it, and is aligned.

The positions of the plate cylinders 11a to 11d relative to the printing sheet are adjusted by plate cylinder position adjusting motors 301 to 303 of the plate cylinder position adjusting devices 3a to 3d of the first to fourth colors (to be described later), as shown in FIG. 2. More specifically, the vertical adjusting motor 301 adjusts the vertical positions of the plate cylinders 11a to 11d, that is, the positions of the plate cylinders 11a to 11d in rotation directions. With this operation, the vertical position of the image printed on the printing sheet is adjusted. Also, the horizontal adjusting motor 302 adjusts the horizontal positions of the plate cylinders 11a to 11d, that is, the axial positions of the plate cylinders 11a to 11d. With this operation, the horizontal position of the image printed on the printing sheet is adjusted. Moreover, the twist direction adjusting motor 303 adjusts the positions of the plate cylinders 11a to 11d in the twist direction, that is, the positions of the plate cylinders 11a to 11d in the tilt directions of their axial lines. With this operation, horizontal twist of the image printed on the printing sheet is adjusted.

### 1.1.2 Arrangement of Plate Registration Preset Apparatus

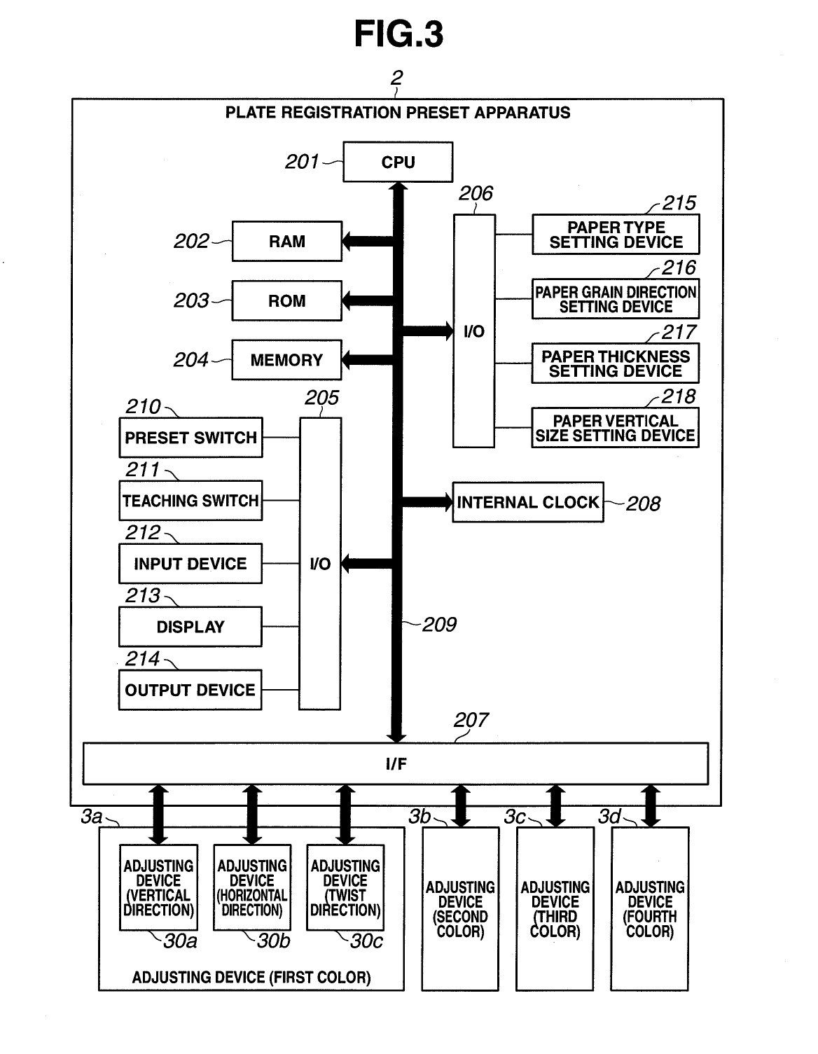

The plate registration preset apparatus 2 includes a CPU (Central Processing Unit) 201, a RAM (Random Access Memory) 202, a ROM (Read Only Memory) 203, a memory 204, input/output interfaces (I/O, I/F) 205 to 207, and an internal clock 208 with a time measurement function, as shown in FIG. 3. These elements 201 to 208 are connected to each other via a communication line 209 such as a bus.

The plate registration preset apparatus 2 also includes a preset switch 210 which detects an operator's operation input, a teaching switch 211 which detects an operator's operation input, an input device 212 implemented by a known interface device such as a keyboard or a mouse, a display 213 implemented by a known display device such as an LCD (Liquid Crystal Display) or an organic EL (Electro Luminescence), and an output device 214 implemented by, for example, a known printer. These elements 210 to 214 are connected to the communication line 209 via the I/O 205.

The plate registration preset apparatus 2 moreover includes a paper type setting device 215 for setting and registering the type of printing sheet, a paper grain direction setting device 216 for setting and registering the grain direction of a printing sheet, a paper thickness setting device 217 for setting and registering the thickness of a printing sheet, and a paper vertical size setting device 218 for setting and registering the vertical size of a printing sheet. These elements 215 to 218 are connected to the communication line 209 via the I/O 206. Note that the grain direction of a printing sheet means the direction in which paper fibers are arrayed. Also, the size of a printing sheet means the outer dimensions of a printing sheet in, for example, the vertical and horizontal directions.

The plate cylinder position adjusting devices 3a to 3d of the first to fourth colors are connected to the I/O 207.

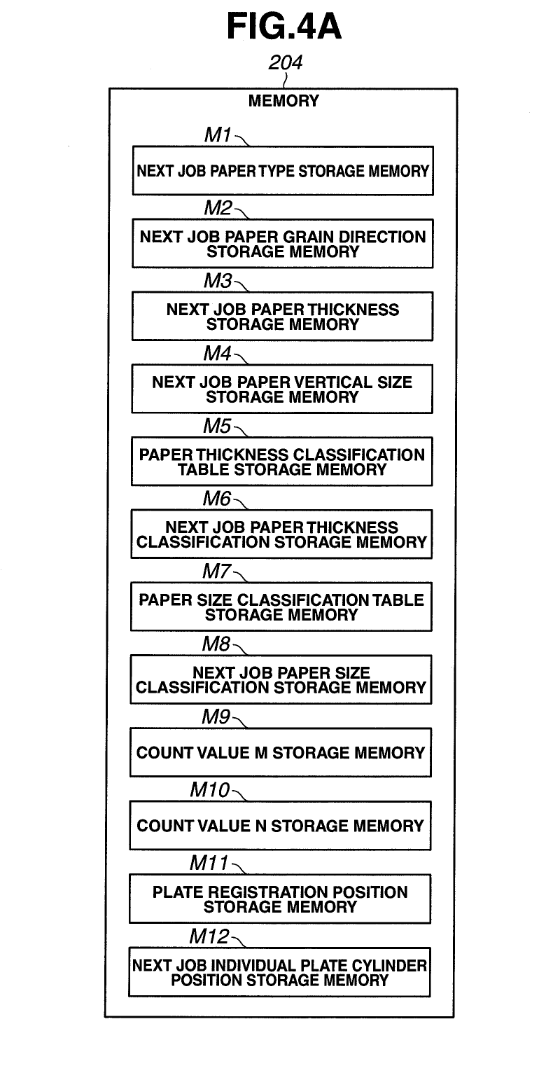

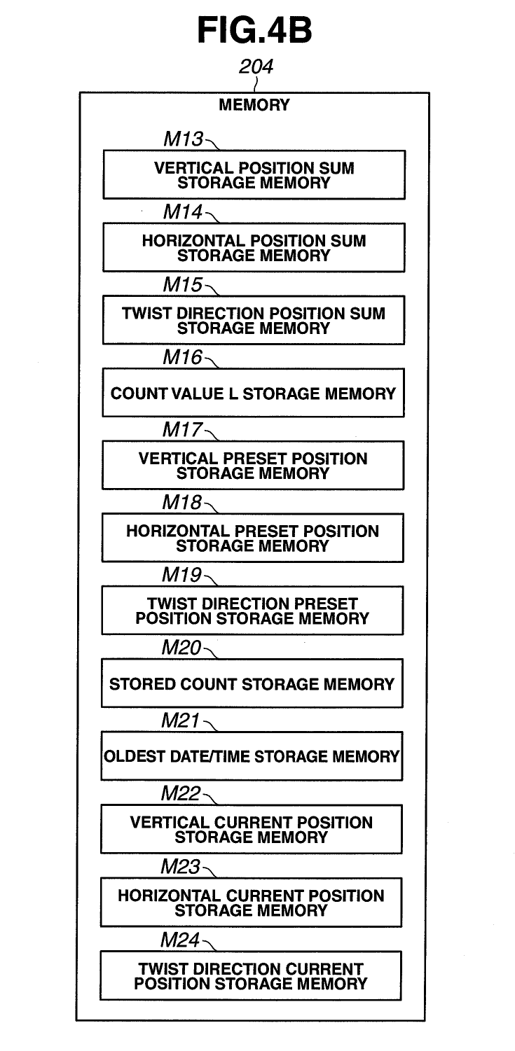

The memory 204 includes memories M1 to M24, as shown in FIGS. 4A and 4B. The next job paper type storage memory M1 stores the type of printing sheet used in the next printing operation (to be referred to as the “next job” hereinafter) by the printing press 1. The next job paper grain direction storage memory M2 stores the grain direction of a printing sheet used in the next job. The next job paper thickness storage memory M3 stores the paper thickness of a printing sheet used in the next job. The next job paper vertical size storage memory M4 stores the vertical size of a printing sheet used in the next job. The paper thickness classification table storage memory M5 stores a paper thickness classification table in which the actual paper thickness is associated with the paper thickness classification, as shown in, for example, Table 1. The next job paper thickness classification storage memory M6 stores the paper thickness classification for the next job. The paper size classification table storage memory M7 stores a paper size classification table in which the actual paper size is associated with the paper size classification, as shown in, for example, Table 2. The next job paper size classification storage memory M8 stores the paper size classification for the next job. The count value M storage memory M9 stores a count value M. The count value N storage memory M10 stores a count value N. The plate registration position storage memory M11 stores pieces of information concerning the address location, the type, grain direction, paper thickness classification, and paper size classification of a printing sheet, the positions of the plate cylinders of the first to fourth colors in the vertical, horizontal, and twist directions, and the storage date/time in association with each other, as shown in, for example, Table 3. The next job individual plate cylinder position storage memory M12 stores the position of each plate cylinder used in the next job. The vertical position sum storage memory M13 of the plate cylinders of the first to fourth colors stores the sums of the vertical positions of the plate cylinders of the first to fourth colors. The horizontal position sum storage memory M14 of the plate cylinders of the first to fourth colors stores the sums of the horizontal positions of the plate cylinders of the first to fourth colors. The twist direction position sum storage memory M15 of the plate cylinders of the first to fourth colors stores the sums of the positions of the plate cylinders of the first to fourth colors in the twist direction. The count value L storage memory M16 stores a count value L. The vertical preset position storage memory M17 of the plate cylinders of the first to fourth colors stores the vertical preset positions of the plate cylinders of the first to fourth colors. The horizontal preset position storage memory M18 of the plate cylinders of the first to fourth colors stores the horizontal preset positions of the plate cylinders of the first to fourth colors. The twist direction preset position storage memory M19 of the plate cylinders of the first to fourth colors stores the preset positions of the plate cylinders of the first to fourth colors in the twist direction. The stored count storage memory M20 stores the count of identical printing sheets, which is stored in the memory M11. The oldest date/time storage memory M21 stores an oldest date/time. The vertical current position storage memory M22 of the plate cylinders of the first to fourth colors stores the vertical current positions of the plate cylinders of the first to fourth colors. The horizontal current position storage memory M23 of the plate cylinders of the first to fourth colors stores the horizontal current positions of the plate cylinders of the first to fourth colors. The twist direction current position storage memory M24 of the plate cylinders of the first to fourth colors stores the current positions of the plate cylinders of the first to fourth colors in the twist direction.

TABLE 1
Paper Thickness Classification Table

Paper Thickness [nm]

| | ~0.10 | 0.10~0.20 | 0.20~0.50 | 0.50~ |
|---|---|---|---|---|
| Paper Thickness | 1 | 2 | 3 | 4 |
| Classification | | | | |

TABLE 2
Paper Size Classification Table

| | Paper Size [nm] | | | |
|---|---|---|---|---|
| | ~500 | 500~1000 | 1000~1500 | 1500~2000 |
| Paper Size | 1 | 2 | 3 | 4 |
| Classification | | | | |

TABLE 3
Data Structure of Plate Registration Position Storage Memory

| | | | | | | | Position | | |
|---|---|---|---|---|---|---|---|---|---|
| | | | | | Vertical | Horizontal | of Plate | Vertical | Horizontal |
| | | | | | Position | Position | Cylinder | Position | Position |
| | | | | | of Plate | of Plate | of First | of Plate | of Plate |
| | | | | | Cylinder | Cylinder | Color in | Cylinder | Cylinder |
| Address | Paper | Paper Grain | Paper Thickness | Paper Size | of First | of First | Twist | of Second | of Second |
| Location | Type | Direction | Classification | Classification | Color | Color | Direction | Color | Color |
| 1 | Coated | Vertical | 1 | 3 | 0.00 | 0.00 | 0.00 | 0.01 | 0.00 |
| | Paper | | | | | | | | |
| 2 | High- | Horizontal | 2 | 2 | 0.00 | 0.00 | 0.00 | 0.02 | 0.00 |
| | quality | | | | | | | | |
| | Paper | | | | | | | | |
| 3 | Matte | Vertical | 3 | 3 | 0.00 | 0.00 | 0.00 | 0.02 | 0.01 |
| | Paper | | | | | | | | |
| 4 | Specialty | None | 2 | 2 | 0.00 | 0.00 | 0.00 | 0.02 | −0.01 |
| | Paper | | | | | | | | |
| 5 | Coated | Horizontal | 1 | 3 | 0.00 | 0.00 | 0.00 | 0.02 | 0.00 |
| | Paper | | | | | | | | |
| 6 | Coated | Vertical | 1 | 3 | 0.00 | 0.00 | 0.00 | 0.01 | 0.01 |
| | Paper | | | | | | | | |

| | Position | | | Position | | | Position | |
|---|---|---|---|---|---|---|---|---|
| | of Plate | Vertical | Horizontal | of Plate | Vertical | Horizontal | of Plate | |
| | Cylinder | Position | Position | Cylinder | Position | Position | Cylinder | |
| | of Second | of Plate | of Plate | of Third | of Plate | of Plate | of Fourth | |
| | Color in | Cylinder | Cylinder | Color in | Cylinder | Cylinder | Color in | |
| Address | Twist | of Third | of Third | Twist | of Fourth | of Fourth | Twist | Storage |
| Location | Direction | Color | Color | Direction | Color | Color | Direction | Date/time |
| 1 | 0.00 | 0.02 | 0.00 | 0.00 | 0.03 | 0.00 | 0.00 | 2012/5/2 |
| | | | | | | | | 9:00 |
| 2 | 0.00 | 0.04 | 0.00 | 0.00 | 0.06 | 0.00 | 0.00 | 2012/5/2 |
| | | | | | | | | 14:00 |
| 3 | 0.01 | 0.04 | 0.01 | 0.01 | 0.06 | 0.01 | 0.01 | 2012/5/3 |
| | | | | | | | | 9:00 |
| 4 | −0.01 | 0.04 | 0.01 | 0.01 | 0.06 | 0.01 | −0.01 | 2012/5/3 |
| | | | | | | | | 15:00 |
| 5 | 0.00 | 0.04 | 0.00 | 0.00 | 0.06 | 0.00 | 0.00 | 2012/5/4 |
| | | | | | | | | 9:30 |
| 6 | 0.01 | 0.02 | 0.01 | 0.01 | 0.03 | 0.01 | 0.01 | 2012/5/4 |
| | | | | | | | | 14:20 |

### 1.1.3 Arrangement of Plate Cylinder Position Adjusting Devices

The plate cylinder position adjusting device 3a of the first color includes a vertical plate cylinder position adjusting device 30a, horizontal plate cylinder position adjusting device 30b, and twist direction plate cylinder position adjusting device 30c, as shown in FIG. 3. Each of the plate cylinder position adjusting devices 3b to 3d of the second to fourth colors similarly includes three plate cylinder position adjusting devices 30a to 30c. The three plate cylinder position adjusting devices 30a to 30c have the same arrangement, except for the plate cylinder position adjusting motors 301 to 303. That is, the vertical plate cylinder position adjusting device 30a drives the vertical adjusting motor 301, the horizontal plate cylinder position adjusting device 30b drives the horizontal adjusting motor 302, and the twist direction plate cylinder position adjusting device 30c drives the twist direction adjusting motor 303.

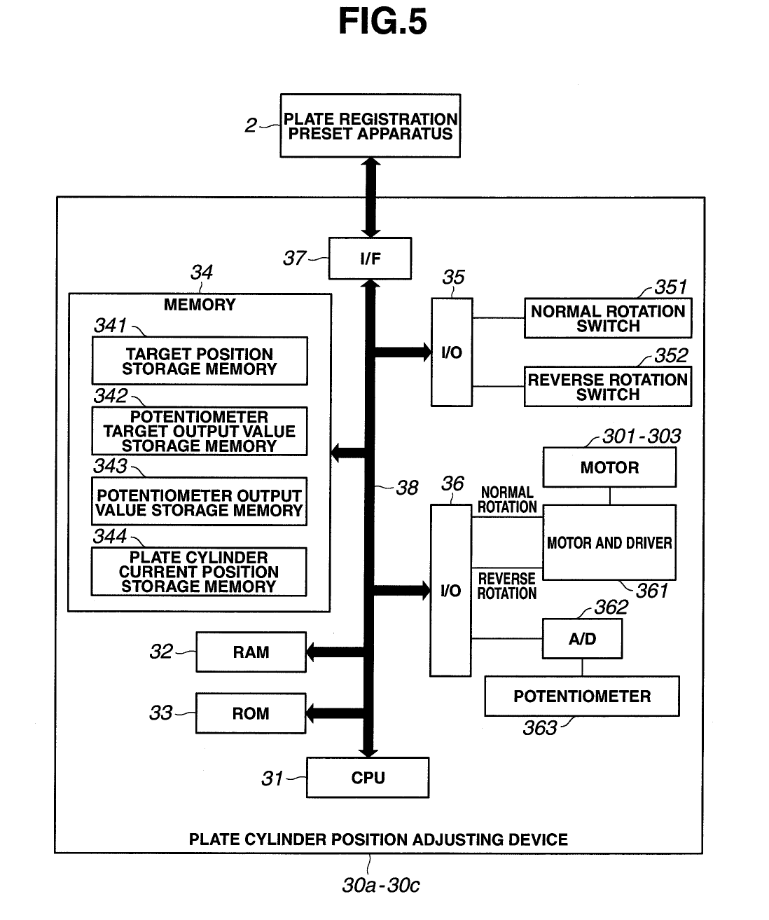

Each of the plate cylinder position adjusting devices 30a to 30c includes a CPU 31, RAM 32, ROM 33, memory 34, and input/output interfaces (I/O, I/F) 35 to 37, as shown in FIG. 5. These elements 31 to 37 are connected to each other via a communication line 38 such as a bus.

The memory 34 includes memories 341 to 344. The target position storage memory 341 stores a target position. The potentiometer target output value storage memory 342 stores the target output value of a plate cylinder position adjusting motor potentiometer 363 (to be described later). The potentiometer output value storage memory 343 stores the output value of the plate cylinder position adjusting motor potentiometer 363 (to be described later). The plate cylinder current position storage memory 344 stores the current positions of the plate cylinders 11a to 11d.

Each of the plate cylinder position adjusting devices 30a to 30c also includes a normal rotation switch 351 which detects an operator's operation input for normally rotating the plate cylinders 11a to 11d, and a reverse rotation switch 352 which detects an operator's operation input for reversely rotating the plate cylinders 11a to 11d. These switches 351 and 352 are connected to the communication line 38 via the I/O 35.

Each of the plate cylinder position adjusting devices 30a to 30c moreover includes a plate cylinder position adjusting motor and driver 361, a plate cylinder position adjusting motor which undergoes driving control by the plate cylinder position adjusting motor and driver 361, an A/D converter 362, and the plate cylinder position adjusting motor potentiometer 363 connected to the A/D converter 362. The plate cylinder position adjusting motor and driver 361 and A/D converter 362 are connected to the communication line 38 via the I/O 36. Note that the plate cylinder position adjusting devices 30a to 30c include the plate cylinder position adjusting motors 301 to 303, respectively.

### 1.2 Schematic Operation of Printing System

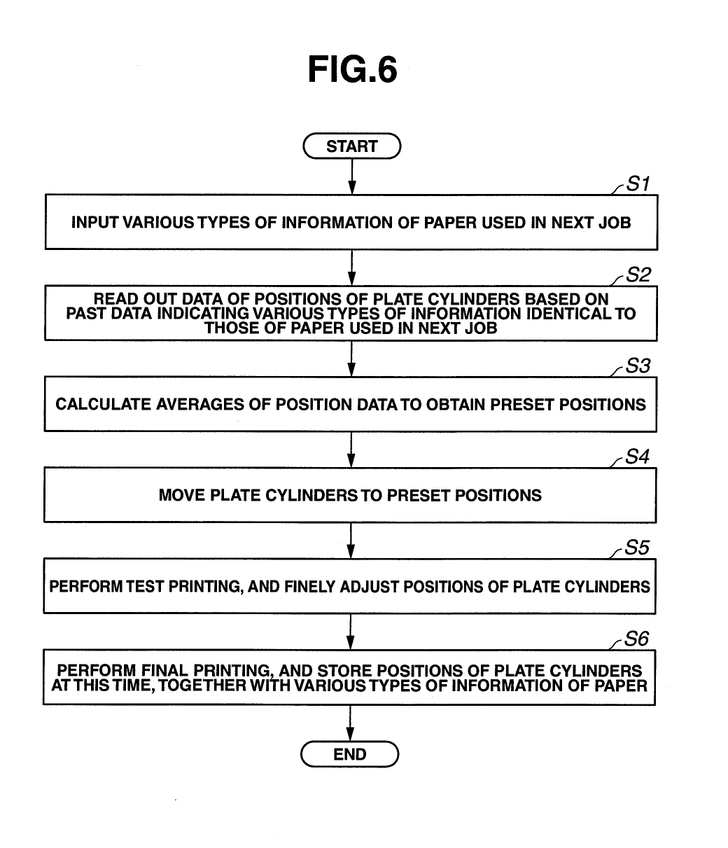

The schematic operation of a printing system equipped with the plate registration preset apparatus 2 will be described next with reference to FIG. 6.

When the printing press 1 starts to print in the next job, the operator inputs various types of information of a printing sheet used in the next job from the setting devices 215 to 218 of the plate registration preset apparatus 2. With this operation, the plate registration preset apparatus 2 receives the type, grain direction, paper thickness, and vertical size of a printing sheet used in the next job (step S1).

The plate registration preset apparatus 2 searches the information stored in the memory 204 for the input various types of information of a printing sheet. The memory 204 stores the various types of information of a printing sheet used in the past final printing operation by the printing press 1, and the positions of the plate cylinders 11a to 11d at that time in association with each other. When data indicating various types of information of a printing sheet, that is, a type, dimension, in the grain direction, paper thickness, and vertical size identical to those of a printing sheet used in the next job are detected, the plate registration preset apparatus 2 reads out the positions of the plate cylinders 11a to 11d in the vertical, horizontal, and twist directions associated with these data from the memory 204. That is, the plate registration preset apparatus 2 reads out the positions of the plate cylinders 11a to 11d in the vertical, horizontal, and twist directions, which are stored in the past, for a printing sheet indicating a type, paper grain direction, paper thickness, and vertical size identical to those of a printing sheet used in the next job (step S2).

Upon reading out a plurality of past position data, the plate registration preset apparatus 2 calculates the averages of the position data of the plate cylinders 11a to 11d for each of the vertical, horizontal, and twist directions. These averages are sent to the plate cylinder position adjusting devices 3a to 3d of the first to fourth colors as the positions to which the plate cylinders 11a to 11d are to be moved, that is, preset positions (step S3). Note that not only the average of past data, such as the moving average or simple average, but also the average of one or a plurality of data designated by the user may be used as a preset position. If only one past data is present, it is sent as a preset position, as a matter of course.

Upon receiving the preset positions from the plate registration preset apparatus 2, the plate cylinder position adjusting devices 3a to 3d of the first to fourth colors move the plate cylinders 11a to 11d to the positions in the vertical, horizontal, and twist directions to the received preset positions (step S4).

After the plate cylinders 11a to 11d move to the preset positions, the operator operates the printing press 1 to perform test printing of the printing product of the next job. If the images of the respective colors have a misregistration, the operator manually performs remote control to finely adjust the positions of the plate cylinders 11a to 11d. When this operation input is detected, the plate cylinder position adjusting devices 3a to 3d of the first to fourth colors move the plate cylinders 11a to 11d to the positions in the vertical, horizontal, and twist directions based on this operation input (step S5). This fine adjustment operation continues until the operator determines that the misregistration is inconspicuous.

The operator operates the printing press 1 to perform final printing of the printing product of the next job. The plate registration preset apparatus 2 stores in the memory 204 the positions of the plate cylinders 11a to 11d in the vertical, horizontal, and twist directions at the time of final printing in association with the type, grain direction, paper thickness, and vertical size of a printing sheet at that time (step S6). This storage operation can be done at the operator timing based on the operator's operation input, such as before the start of final printing, during final printing, or after the end of final printing.

As described above, when the printing press 1 starts to print on a printing sheet, the plate registration preset apparatus 2 determines whether information concerning a printing sheet having a type, grain direction, paper thickness, and vertical size identical to those of a printing sheet to be printed is stored in the memory 204. If identical information is stored in the memory 204, the plate cylinders 11a to 11d are moved to the positions in the vertical, horizontal, and twist directions stored in the memory 204 in association with the information concerning that printing sheet. For this reason, the operator need not adjust the positions of the plate cylinders 11a to 11d from the initial state where registration is not done at all, so his or her burden can be relieved. Also, since the registration accuracy improves, the number of repetitions of test printing can be reduced, thus preventing a decrease in operating ratio of the printing press, and waste of printing materials.

Also, conventionally, the strength with which an end customer perceives a misregistration varies depending on both the degree of overlapping of the respective colors in the corresponding portions of the printed printing product, and the patterns of images of the printed printing product. It is often the case that, for example, a misregistration becomes conspicuous when the same printing material (the types of damping water and ink) is used for an identical type of printing sheet, or the misregistration is uniformed in respective directions. For this reason, only a skilled operator allows a registration operation. However, according to this embodiment, the plate cylinders 11a to 11d are moved to the positions adjusted by a skilled operator, even an unskilled operator can achieve highly accurate registration.

### 1.3 Detailed Operation of Plate Registration Preset Apparatus

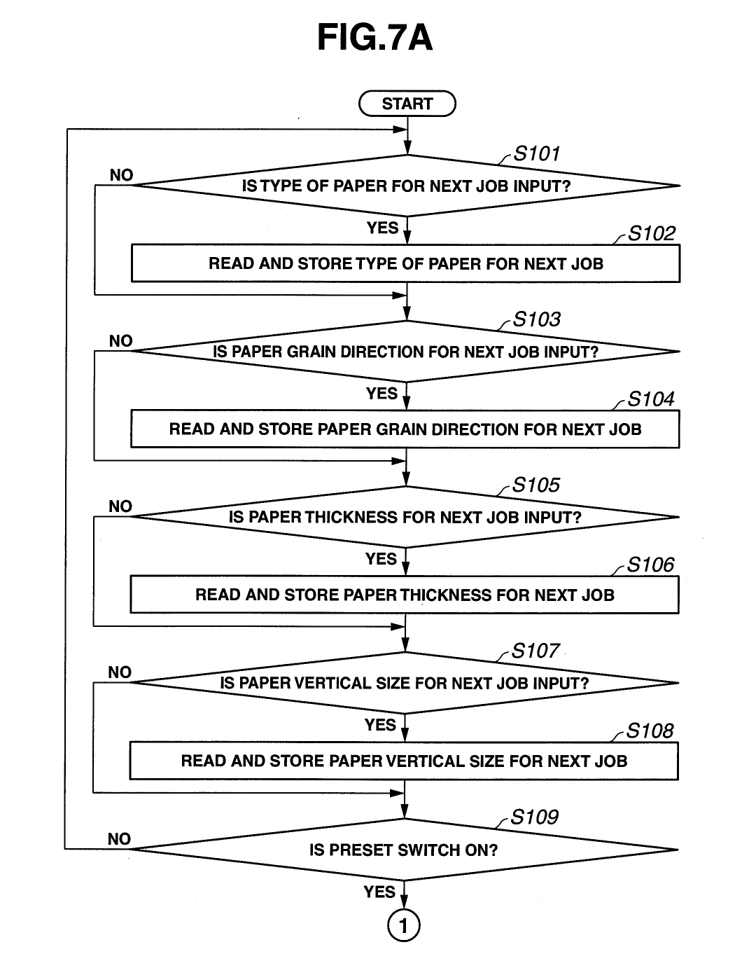

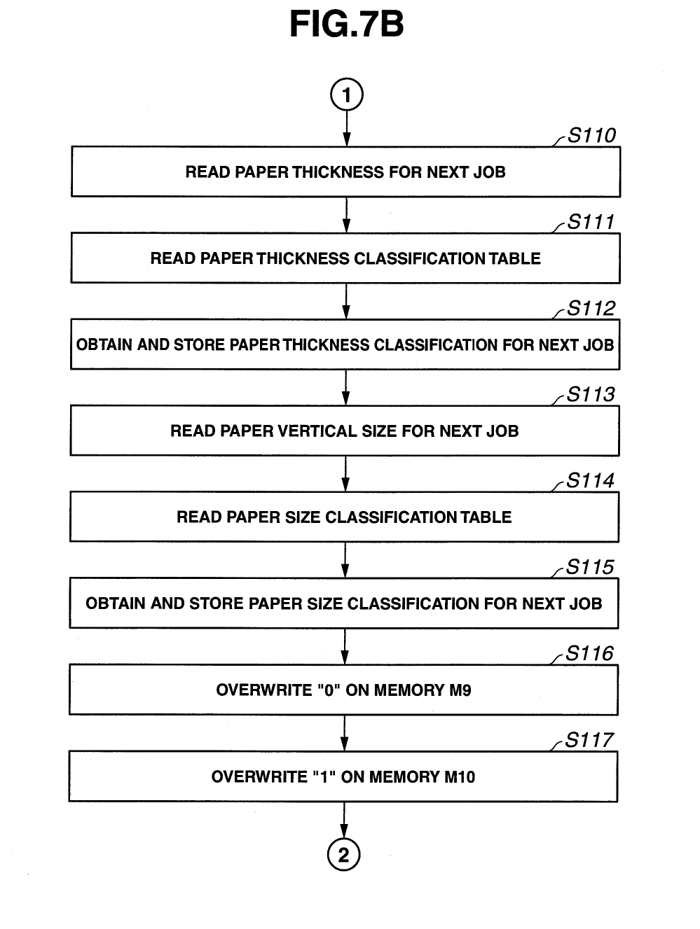

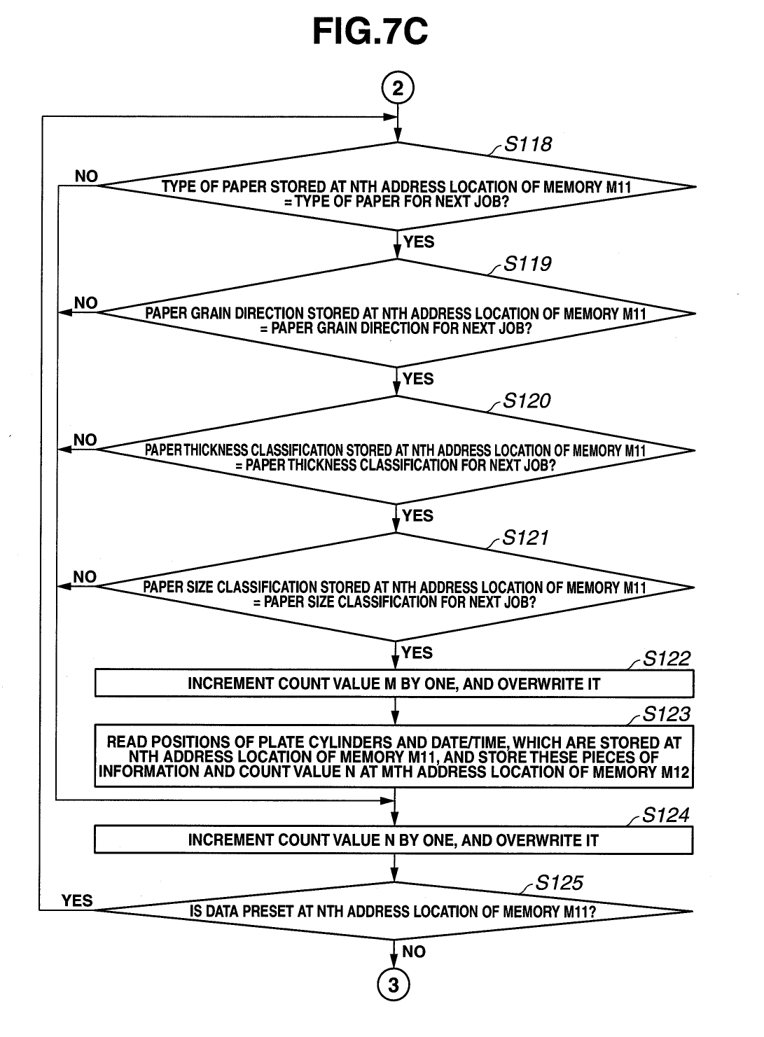

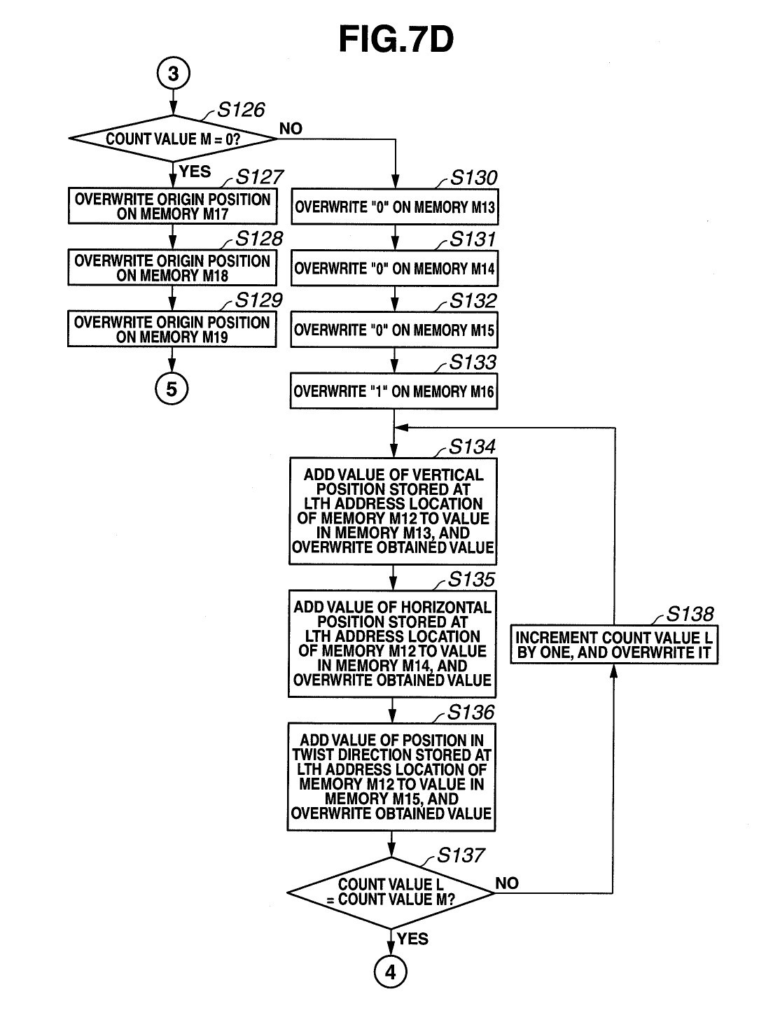

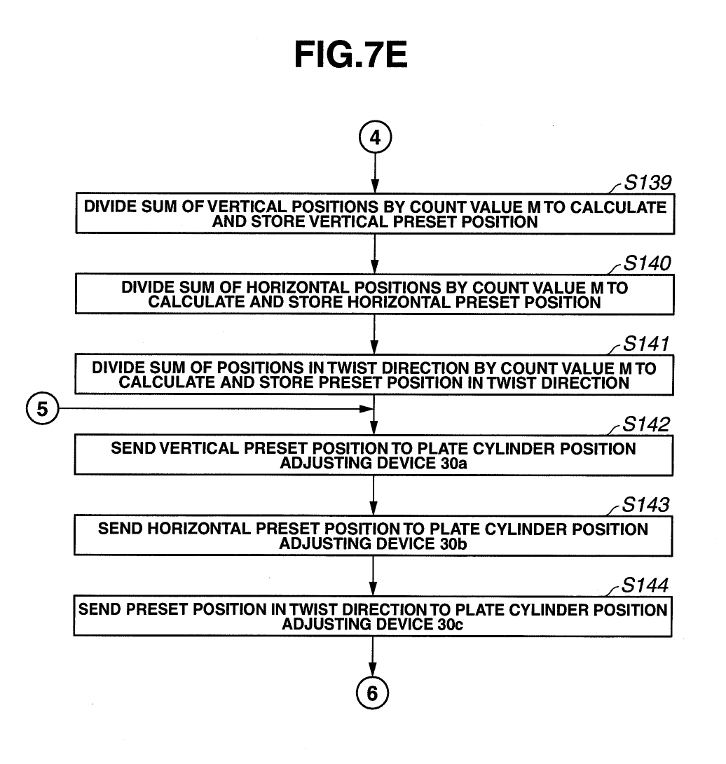

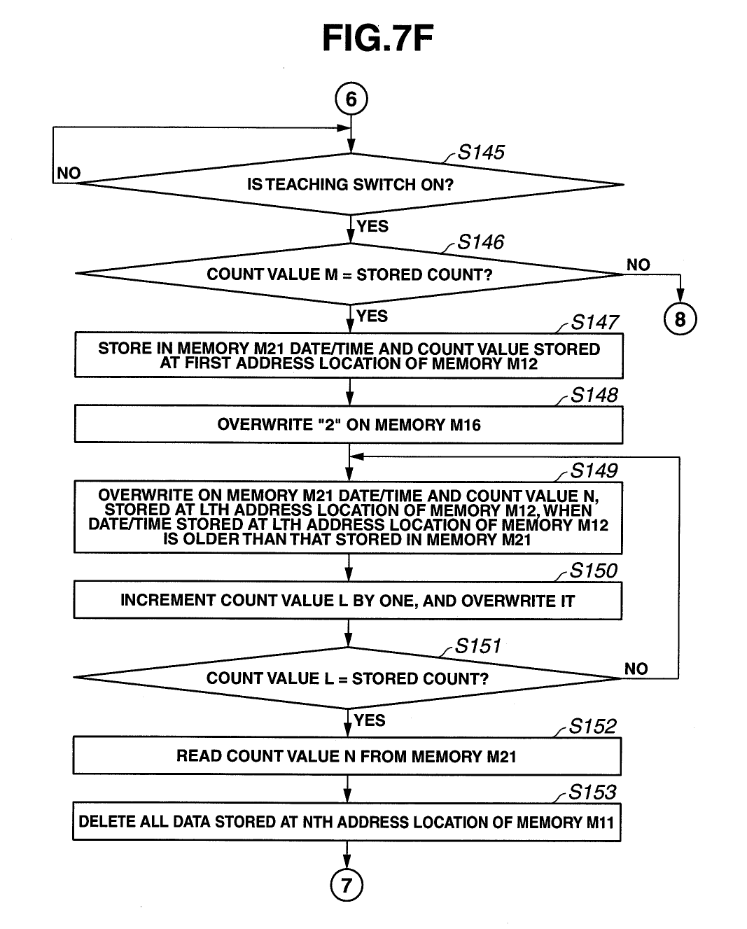

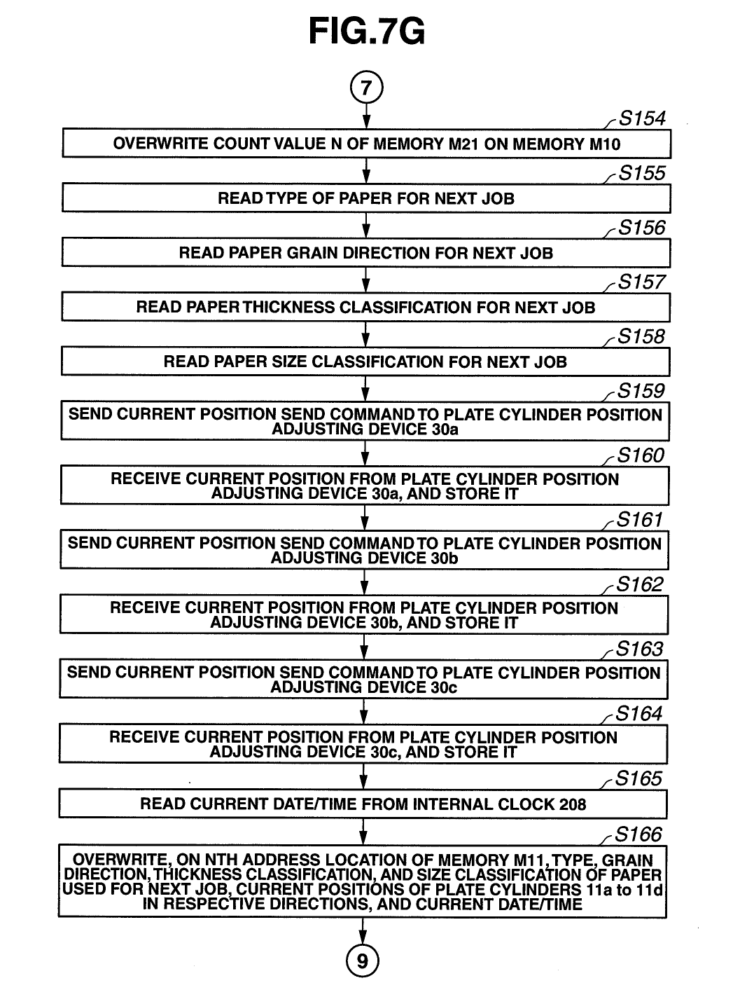

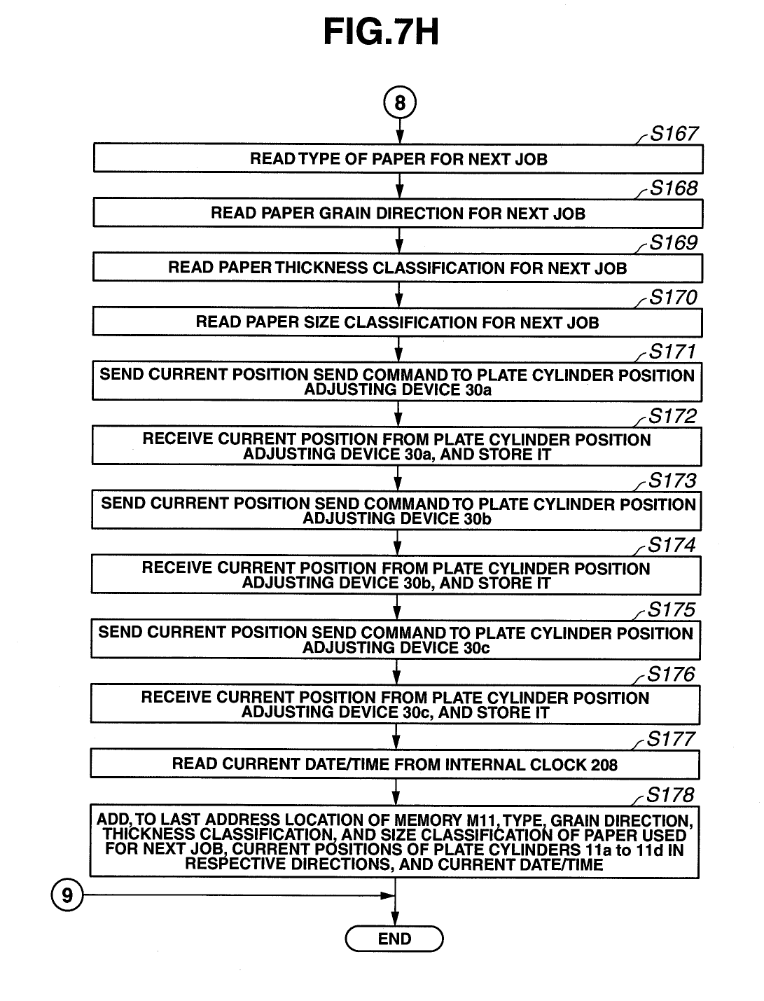

The detailed operation of the plate registration preset apparatus 2 will be described next with reference to FIGS. 7A to 7H.

When printing of the next job starts, the operator inputs various types of information associated with a printing sheet used in the next job and, more specifically, the type, grain direction, paper thickness, and vertical direction of a printing sheet to the setting devices 215 to 218.

As shown in FIG. 7A, if the CPU (processor) 201 confirms that the type of printing sheet used in the next job has been input (YES in step S101), it reads the type of printing sheet input via the paper type setting device 215, and stores it in the memory M1 (step S102). On the other hand, if the type of printing sheet for the next job has not been input (NO in step S101), the CPU 201 directly advances the process to step S103.

If the CPU 201 confirms that the grain direction of a printing sheet used in the next job has been input (YES in step S103), it reads the grain direction of a printing sheet input via the paper grain direction setting device 216, and stores it in the memory M2 (step S104). On the other hand, if the grain direction of a printing sheet for the next job has not been input (NO in step S103), the CPU 201 directly advances the process to step S105.

If the CPU 201 confirms that the paper thickness of a printing sheet used in the next job has been input (YES in step S105), it reads the paper thickness of a printing sheet input via the paper thickness setting device 217, and stores it in the memory M3 (step S106). On the other hand, if the paper thickness of a printing sheet for the next job has not been input (NO in step S105), the CPU 201 directly advances the process to step S107.

If the CPU 201 confirms that the vertical size of a printing sheet used in the next job has been input (YES in step S107), it reads the vertical size of a printing sheet input via the paper vertical size setting device 218, and stores it in the memory M4 (step S108). On the other hand, if the vertical size of a printing sheet for the next job has not been input (NO in step S107), the CPU 201 directly advances the process to step S109.

The above-mentioned steps S101 to S108 are repeated until the operator presses the preset switch 210 upon determining that all of the type, grain direction, paper thickness, and vertical size of a printing sheet have been input.

The operator ends the input operation of information associated with a printing sheet used in the next job, and turns on the preset switch 210. If the CPU 201 confirms that the preset switch 210 is ON (YES in step S109), it performs, for example, classification of the paper thickness and size of a printing sheet used in the next job, as shown in FIG. 7B.

More specifically, the CPU 201 reads the paper thickness of a printing sheet used in the next job from the memory M3 (step S110), reads from the memory M5 a paper thickness classification table as shown in Table 1 (step S111), obtains the paper thickness classification of a printing sheet used in the next job from the paper thickness for the next job using the paper thickness classification table, and stores it in the memory M6 (step S112).

The CPU 201 also reads the vertical size of a printing sheet used in the next job from the memory M4 (step S113), reads from the memory M7 a paper size classification table as shown in Table 2 (step S114), obtains the paper vertical size classification of a printing sheet used in the next job from the size for the next job using the paper size classification table, and stores it in the memory M8 (step S115).

The CPU 201 overwrites the count value M in the memory M9 with M=0 (step S116), and overwrites the count value N in the memory M10 with N=1 (step S117).

The CPU 201 extracts a printing sheet of a type identical to that of a printing sheet used in the next job from the memory M11, as shown in FIG. 7C.

More specifically, the CPU 201 determines whether the type of printing sheet stored at the Nth address location of the memory M11 is identical to that of printing sheet used in the next job, which is stored in the memory M1 (step S118).

If the type of printing sheet is identical (YES in step S118), the CPU 201 determines whether the grain direction of a printing sheet stored at the Nth address location of the memory M11 is identical to that of a printing sheet used in the next job, which is stored in the memory M2 (step S119).

If the grain direction of a printing sheet is identical (YES in step S119), the CPU 201 determines whether the paper thickness classification of a printing sheet stored at the Nth address location of the memory M11 is identical to that of a printing sheet used in the next job, which is stored in the memory M6 (step S120).

If the paper thickness classification is identical (YES in step S120), the CPU 201 determines whether the paper size classification of a printing sheet stored at the Nth address location of the memory M11 is identical to that of a printing sheet used in the next job, which is stored in the memory M8 (step S121).

If the paper size classification is identical (YES in step S121), the CPU 201 increments the count value M in the memory M9 by one, and overwrites it on the memory M9 (step S122). The CPU 201 reads the values of the positions, in the vertical, horizontal, and twist directions, of the plate cylinders 11a to 11d of the first to fourth colors stored at the Nth address locations in the memory M11, and the date/time when these values are stored, and stores the locations, date/time, and count value N at the Mth address location of the memory M12 (step S123). The CPU 201 increments the count value N in the memory M10 by one, and overwrites it on the memory M10 (step S124), and then determines whether data is present at the Nth address location of the memory M11 (step S125).

On the other hand, if one of the type, grain direction, paper thickness classification, and paper size classification of a printing sheet is different (NO in one of steps S118 to S121), the CPU 201 executes processes in steps S124 and S125.

If data is present at the Nth address location of the memory M11 (YES in step S125), data which has not yet been compared to determine whether the type of printing sheet is identical to that of printing sheet for the next job is present in the memory M11, so the CPU 201 returns the process to step S118. Upon repetitions of the processes in steps S118 to S124 in this way, the memory M12 stores the values of the positions, in the vertical, horizontal, and twist directions, of the plate cylinders 11a to 11d of the first to fourth colors upon the past final printing operation of a printing sheet having a type, grain direction, paper thickness classification, and paper size classification identical to those of a printing sheet for the next job, the date/time when these values are stored, and the count value N.

On the other hand, if data is absent at the Nth address location of the memory M11 (NO in step S125), data to be compared to determine whether the type of printing sheet is identical to that of printing sheet for the next job is absent, so the CPU 201 executes a preliminary process of registering preset positions, as shown in FIG. 7D.

More specifically, first, the CPU 201 confirms whether the count value M in the memory M9 is M=0 (step S126).

If the count value M is M=0 (YES in step S126), this means that data of an identical printing sheet has not been stored in the memory M11. Therefore, the CPU 201 overwrites on the memories M17 to M19 the origin positions of the plate cylinders 11a to 11d in the respective directions (vertical, horizontal, and twist directions) (steps S127-S129), and advances the process to step S142 (to be described later).

On the other hand, if the count value M is M≠0 (NO in step S126), this means that data of an identical printing sheet has been stored in the memory M11. The CPU 201 overwrites “0s” on the memories M13 to M15 to reset them (steps S130 to S132), and overwrites the count value L in the memory M16 with L=1 (step S133). Of the data stored in the memory M12 upon the above-mentioned process in step S123, the values of the vertical positions of the plate cylinders 11a to 11d of the first to fourth colors stored at the Lth address location are added to those in the memory M13 for each of the plate cylinders 11a to 11d to overwrite these values on the memory M13 (step S134). Similarly, the values of the positions, in the horizontal and twist directions, of the plate cylinders 11a to 11d of the first to fourth colors stored at the Lth address location of the memory M12 are added to those in the memories M14 and M15, respectively, for each of the plate cylinders 11a to 11d to overwrite these values on the memories M14 and M15 (steps S135 & S136).

The CPU 201 confirms whether the count value L in the memory M16 is equal to the count value M in the memory M9 (step S137).

If the count values L and M are different (NO in step S137), this means that data which has not been added to those in the memories M13 to M15 is present in the memory M12. Therefore, the CPU 201 increments the count value L in the memory M16 by one, and overwrites it on the memory M16 (step S138). The CPU 201 then returns the process to step S134.

On the other hand, if the count values L and M are equal (YES in step S137), this means that all data in the memory M12 have been added to those in the memories M13 to M15. In this case, the CPU 201 executes a process of registering preset positions, as shown in FIG. 7E.

Again in this case, the CPU 201 divides the sums of the vertical positions of the plate cylinders 11a to 11d of the first to fourth colors stored in the memory M13 by the count value M in the memory M9 to calculate the averages of data of identical printing sheets stored in the memory M11, and stores these averages in the memory M17 as preset positions (step S139). Similarly, the CPU 201 divides the sums of the positions, in the horizontal and twist directions, of the plate cylinders 11a to 11d of the first to fourth colors stored in the memories M14 and M15 by the count value M to calculate preset positions, and stores them in the memories M18 and M19 (steps S140 & S141).

The CPU 201 sends the preset positions in the respective directions stored in the memories M17 to M19 to the vertical plate cylinder position adjusting device 30a, horizontal plate cylinder position adjusting device 30b, and twist direction plate cylinder position adjusting device 30c of each of the plate cylinder position adjusting devices 3a to 3d of the first to fourth colors (steps S142-S144). The plate cylinder position adjusting devices 3a to 3d of the first to fourth colors move the plate cylinders 11a to 11d to the positions in the vertical, horizontal, and twist directions to the preset positions sent from the plate registration preset apparatus 2. For this reason, the operator need not adjust the positions of the plate cylinders from the initial state, so the burden required for adjustment can be relieved.

When the plate cylinders 11a to 11d have moved to the preset positions using the above-mentioned method, the operator operates the printing press 1 to perform test printing, and manually, finely adjusts the positions of the plate cylinders 11a to 11d as needed (step S5 in FIG. 6). If the operator determines that final printing of the next job can be done, he or she turns on the teaching switch 211 to newly register the positions of the plate cylinders 11a to 11d at that time (step S6 in FIG. 6).

As shown in FIG. 7F, if the CPU 201 confirms that the teaching switch 211 is ON (YES in step S145), it confirms whether the count value M in the memory M9 is equal to the count stored in the memory M20 (step S146). Note that when the respective conditions of a printing sheet and the positions of the plate cylinders 11a to 11d are stored while printing is actually in progress or after the end of printing, the “next job” should be replaced with the “current job”. However, in this case, since the conditions of a printing sheet and the positions of the plate cylinders 11a to 11d at that time are stored in the memory M11 before final printing, a description will be given directly using the expression “next job”.

If the count value M is equal to the count stored in the memory M20 (YES in step S146), data of a printing sheet identical to that used in the next job is already stored in the memory M11 in an amount corresponding to the stored count. Therefore, the CPU 201 deletes oldest data from the memory M11, and stores in the memory M11 the positions of the plate cylinders 11a to 11d, where final printing is permitted by the operator. With this operation, moving averages are calculated as preset values, so values corresponding to the recent trends of the printing press 1 and printing sheet are generated.

More specifically, the CPU 201 stores in the memory M21 the count value N and the first date/time stored in the memory M12 (step S147), and overwrites the count value L in the memory M16 with L=2 (step S148). If the date/time stored at the Lth address location of the memory M12 is determined to be older than that stored in the memory M21 in their comparison, the count value L and the date/time stored at the Lth address location are overwritten on the memory M21 (step S149). The CPU 201 increments the count value L in the memory M16 by one, overwrites it on the memory M16 (step S150), and then confirms whether the count value L in the memory M16 is equal to the count stored in the memory M20 (step S151).

If those values are different (NO in step S151), a comparison with the data of an identical printing sheet in the memory M12 has not ended, so the CPU 201 returns the process to step S149.

On the other hand, if those values are equal (YES in step S151), a comparison with the data of an identical printing sheet in the memory M12 has ended. The CPU 201 reads the count value N from the memory M21 (step S152), and deletes all data stored at the Nth address location in the memory M11 (step S153). With this operation, oldest data identical to those of a printing sheet used in the next job, which is stored in the memory M12, is deleted.

To register the positions, where final printing is permitted by the operator, instead of the deleted data, the CPU 201 overwrites on the memory M10 the count value N stored in the memory M21 (step S154), and reads the type, grain direction, paper thickness classification, and paper size classification of a printing sheet used in the next job from the memories M1, M2, M6, and M8 (steps S155-S158). The CPU 201 sends commands to send the current positions of the plate cylinders 11a to 11d in the respective directions to the vertical plate cylinder position adjusting device 30a, horizontal plate cylinder position adjusting device 30b, and twist direction plate cylinder position adjusting device 30c of each of the plate cylinder position adjusting devices 3a to 3d of the first to fourth colors (steps S159, S161, & S163). Upon receiving the current positions, in the respective directions, of the plate cylinders 11a to 11d sent from the devices 30a to 30c in response to these commands, the CPU 201 stores the received current positions in the respective directions in the memories M22 to M24 (steps S160, S162, & S164). The CPU 201 also reads from the internal clock 208 the current date/time, that is, the time at which the teaching switch 211 is pressed (step S165). Then, the CPU 201 overwrites on the Nth address location of the memory M11 the type, grain direction, paper thickness classification, and paper size classification of a printing sheet used in the next job, the current positions of the plate cylinders 11a to 11d of the first to fourth colors in the vertical, horizontal, and twist directions, and the current date/time, which are obtained in the above-mentioned steps S155 to S158, S160, S162, S164, and S165 (step S166). With this operation, oldest data identical to those of a printing sheet used in the next job, which is stored in the memory M12, is rewritten with most recent positions where final printing is permitted by the operator.

On the other hand, if the count value M is different from the count stored in the memory M20 (NO in step S145), data of a printing sheet identical to that used in the next job is already stored in the memory M11 in an amount corresponding to the stored count, so the CPU 201 stores in the memory M11 the positions where final printing is permitted by the operator, as shown in FIG. 7H.

More specifically, the CPU 201 reads the type, grain direction, paper thickness classification, and paper size classification of a printing sheet used in the next job from the memories M1, M2, M6, and M8 (steps S167-S170). The CPU 201 sends commands to send the current positions of the plate cylinders 11a to 11d in the respective directions to the vertical plate cylinder position adjusting device 30a, horizontal plate cylinder position adjusting device 30b, and twist direction plate cylinder position adjusting device 30c of each of the plate cylinder position adjusting devices 3a to 3d of the first to fourth colors (steps S171, S173, & S175). Upon receiving the current positions, in the respective directions, of the plate cylinders 11a to 11d sent from the devices 30a to 30c in response to these commands, the CPU 201 stores the received current positions in the respective directions in the memories M22 to M24 (steps S172, S174, & S176). The CPU 201 also reads from the internal clock 208 the current date/time, that is, the time at which the teaching switch 211 is pressed (step S177). Then, the CPU 201 adds, to the last address location of the memory M11, the type, grain direction, paper thickness classification, and paper size classification of a printing sheet used in the next job, the current positions of the plate cylinders 11a to 11d of the first to fourth colors in the vertical, horizontal, and twist directions, and the current date/time, which are obtained in the above-mentioned steps S167 to S170, S172, S174, S176, and S177 (step S178). With this operation, most recent positions where final printing is permitted by the operator are stored in the memory M11.

### 1.4 Operation of Plate Cylinder Position Adjusting Device

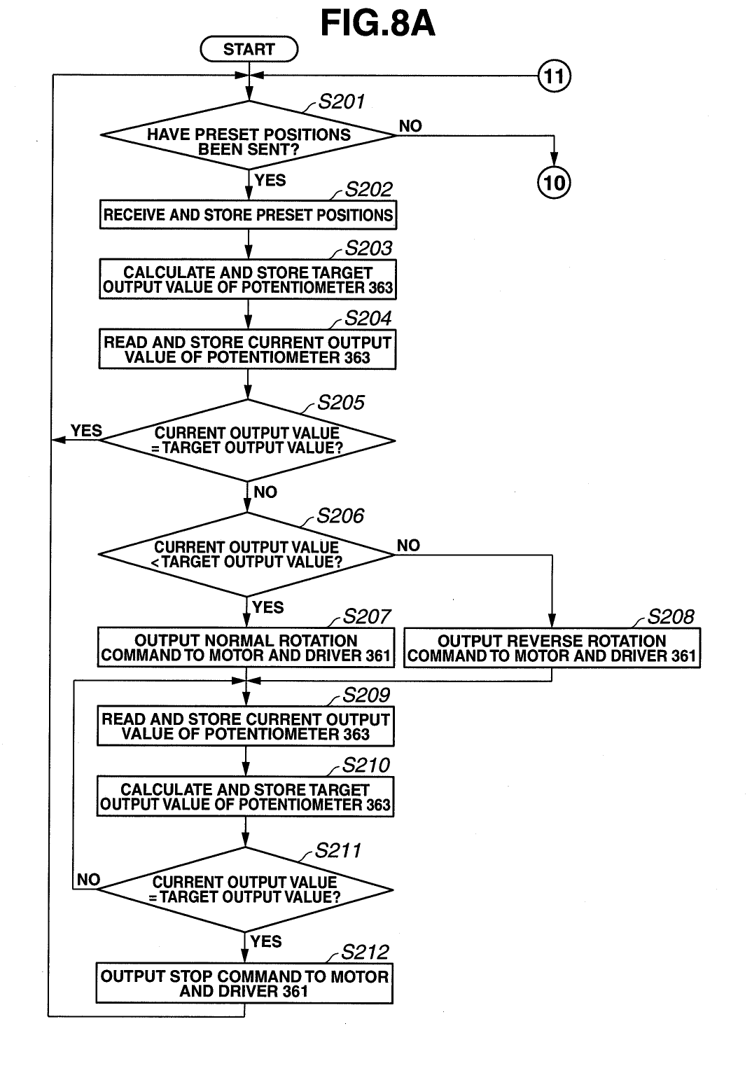

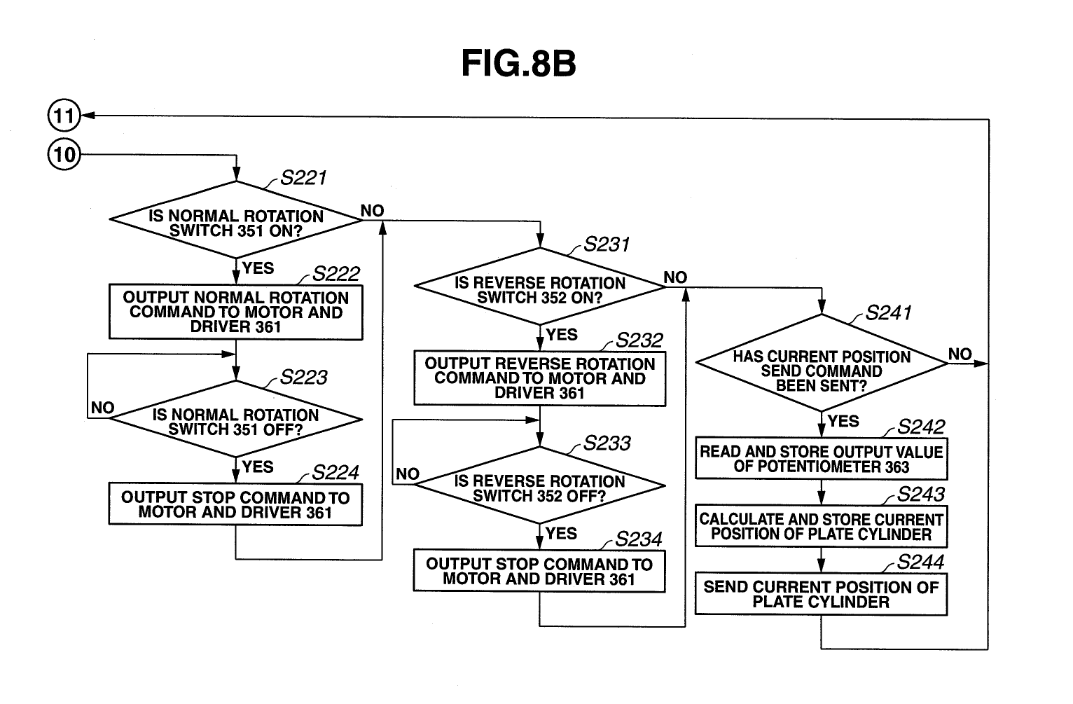

The operation of the plate cylinder position adjusting device will be described next with reference to FIGS. 8A and 8B. The operation of the vertical plate cylinder position adjusting device 30a in the plate cylinder position adjusting device 3a of the first color will be described herein.

First, the CPU 31 of the plate cylinder position adjusting device 30a confirms whether preset positions have been sent by the plate registration preset apparatus 2 (step S201).

If preset positions have been sent (YES in step S201), the CPU 31 receives and stores them in the memory 341 (step S202). Based on the received preset positions, the CPU 31 calculates the target output value of the plate cylinder position adjusting motor potentiometer 363, and stores it in the memory 342 (step S203). The plate cylinder position adjusting motor potentiometer 363 of the plate cylinder position adjusting device 30a detects the rotation angle of the plate cylinder position adjusting motor 301. The target output value of the potentiometer 363 is a value expected to be output from the potentiometer 363 when the plate cylinder 11a of the first color completes its movement to the vertical preset position.

The CPU 31 reads the current output value of the plate cylinder position adjusting motor potentiometer 363 via the A/D converter 362, and stores it in the memory 343 (step S204).

The CPU 31 confirms whether the values stored in the memories 342 and 343, that is, the target output value of the plate cylinder position adjusting motor potentiometer 363 is equal to the current output value of the plate cylinder position adjusting motor potentiometer 363 (step S205).

If the target output value of the plate cylinder position adjusting motor potentiometer 363 is equal to the current output value of the plate cylinder position adjusting motor potentiometer 363 (YES in step S205), the current position of the plate cylinder 11a has already become the vertical preset position. The CPU 31 thus returns the process to step S201.

On the other hand, if the target output value of the plate cylinder position adjusting motor potentiometer 363 is different from the current output value of the plate cylinder position adjusting motor potentiometer 363 (NO in step S205), the current position of the plate cylinder 11a has not yet become the vertical preset position. In this case, the CPU 31 confirms whether the value in the memory 343 is smaller than that in the memory 342, that is, whether the current output value of the plate cylinder position adjusting motor potentiometer 363 is smaller than the target output value of the plate cylinder position adjusting motor potentiometer 363 (step S206).

The current output value of the plate cylinder position adjusting motor potentiometer 363 is smaller than the target output value of the plate cylinder position adjusting motor potentiometer 363 (YES in step S206), the CPU 31 outputs a command to normally rotate the vertical adjusting motor 301 to the plate cylinder position adjusting motor and driver 361 (step S207).

On the other hand, if the current output value of the plate cylinder position adjusting motor potentiometer 363 is larger than the target output value of the plate cylinder position adjusting motor potentiometer 363 (NO in step S206), the CPU 31 outputs a command to reversely rotate the vertical adjusting motor 301 to the plate cylinder position adjusting motor and driver 361 (step S208).

When a command is output to the plate cylinder position adjusting motor and driver 361, the CPU 31 reads the current output value of the plate cylinder position adjusting motor potentiometer 363 via the A/D converter 362, and stores it in the memory 343 (step S209). Also, the CPU 31 reads the target output value of the plate cylinder position adjusting motor potentiometer 363 from the memory 342 (step S210). Then, the CPU 31 confirms whether the target output value of the plate cylinder position adjusting motor potentiometer 363 is equal to the current output value of the plate cylinder position adjusting motor potentiometer 363 (step S211).

If the target output value of the plate cylinder position adjusting motor potentiometer 363 is equal to the current output value of the plate cylinder position adjusting motor potentiometer 363 (YES in step S205), the current position of the plate cylinder 11a has already become the vertical preset position. Therefore, the CPU 31 outputs a stop command to the plate cylinder position adjusting motor and driver 361 (step S212), and returns the process to step S201.

On the other hand, if the target output value of the plate cylinder position adjusting motor potentiometer 363 is different from the current output value of the plate cylinder position adjusting motor potentiometer 363 (NO in step S205), the current position of the plate cylinder 11a has not yet become the vertical preset position, so the CPU 31 returns the process to step S209. The plate cylinder position adjusting motor 301 thus continues to be driven.

The case wherein the operator manually moves the vertical position of the plate cylinder 11a will be described next.

If no preset positions have been sent (NO in step S201), the CPU 31 confirms whether the normal rotation switch 351 is ON (step S221).

If, for example, the operator turns on the normal rotation switch 351 to finely adjust the vertical position of the plate cylinder 11a (YES in step S221), the CPU 31 outputs a command to normally rotate the plate cylinder position adjusting motor 301 to the plate cylinder position adjusting motor and driver 361 (step S222). If, for example, the operator then turns off the normal rotation switch 351 as the plate cylinder 11a moves to his or her desired position (YES in step S223), the CPU 31 outputs a command to stop the plate cylinder position adjusting motor 301 to the plate cylinder position adjusting motor and driver 361 (step S224), and advances the process to step S231.

If the normal rotation switch 351 is OFF (NO in step S221), the CPU 31 confirms whether the reverse rotation switch 352 is ON (step S231).

If, for example, the operator turns on the reverse rotation switch 352 to finely adjust the vertical position of the plate cylinder 11a (YES in step S231), the CPU 31 outputs a command to reversely rotate the plate cylinder position adjusting motor 301 to the plate cylinder position adjusting motor and driver 361 (step S232). If, for example, the operator then turns off the reverse rotation switch 352 as the plate cylinder 11a moves to his or her desired position (YES in step S233), the CPU 31 outputs a command to stop the plate cylinder position adjusting motor 301 to the plate cylinder position adjusting motor and driver 361 (step S234), and advances the process to step S241.

If the reverse rotation switch 352 is OFF (NO in step S231), the CPU 31 confirms whether a command to send the current position of the plate cylinder 11a by the plate registration preset apparatus 2 has been received (step S241).

If that command has not been received (NO in step S241), the CPU 31 returns the process to step S201.

On the other hand, if that command has been received (YES in step S241), the CPU 31 reads the output value of the plate cylinder position adjusting motor potentiometer 363 via the A/D converter 362, and stores it in the memory 343 (step S242). Also, the CPU 31 calculates the current position of the plate cylinder 11a from the output value of the plate cylinder position adjusting motor potentiometer 363, and stores the value of this current position in the memory 344 (step S243). The CPU 31 sends the current position of the plate cylinder 11a to the plate registration preset apparatus 2 (step S244), and returns the process to step S201.

The operation of the vertical plate cylinder position adjusting device 30a in the plate cylinder position adjusting device 3a of the first color has been described above. For the horizontal and twist direction plate cylinder position adjusting devices 30b and 30c, it is only necessary to replace the vertical plate cylinder position adjusting motor 301 with the horizontal plate cylinder position adjusting motor 302 and twist direction plate cylinder position adjusting motor 303, and the vertical preset position with the preset positions in the horizontal and twist directions. Also, for the plate cylinder position adjusting devices 3b to 3d of the second to fourth colors, it is only necessary to replace the plate cylinder 11a of the first color with the plate cylinders 11b to 11d of the second to fourth colors.

### 1.5 Effect of First Embodiment

In this embodiment, data (type, grain direction, paper thickness classification, and paper size classification) of a printing sheet in a final printing operation, and the positions of the plate cylinders 11a to 11d in the respective directions in the final printing operation are stored in association with each other in advance (step S145 in FIG. 7F-step S178 in FIG. 7H & steps S241-S244 in FIG. 8A). When the printing press 1 prints on a printing sheet, it is determined whether the data of this printing sheet is identical to that of a printing sheet at the time of final printing. If it is determined as a result of determination that the data of an identical printing sheet is present, the plate cylinders 11a to 11d are moved to the positions in the respective directions stored in association with the data of an identical printing sheet (step S101 in FIG. 7A-step S144 in FIG. 7E & steps S201-S212 in FIG. 8A). For this reason, the operator need not adjust the positions of the plate cylinders from the initial state where registration is not done at all, so his or her burden can be relieved. Also, since the registration accuracy improves, the number of repetitions of test printing can be reduced, thus preventing a decrease in operating ratio of the printing press, and waste of printing materials.

### 2. Second Embodiment

The second embodiment according to the present invention will be described next. Note that the second embodiment is different from the first embodiment in the partial arrangement of a plate registration preset apparatus used. Hence, the same names and reference numerals as in the first embodiment denote the same constituent elements in the second embodiment, and a description thereof will be omitted as needed.

### 2.1 Arrangement of Printing System

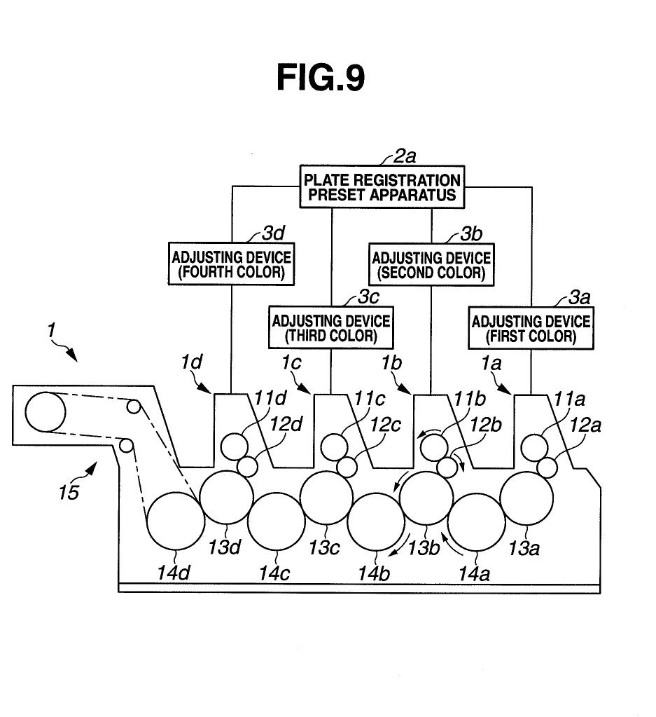

A printing system shown in FIG. 9 includes a printing press 1, a plate registration preset apparatus 2a which stores the positions of plate cylinders 11a to 11d of the printing press 1, and outputs them as needed, and plate cylinder position adjusting devices 3a to 3d of first to fourth colors, which adjust the positions of the plate cylinders 11a to 11d of the printing press 1.

### 2.1.1 Configuration of Plate Registration Preset Apparatus

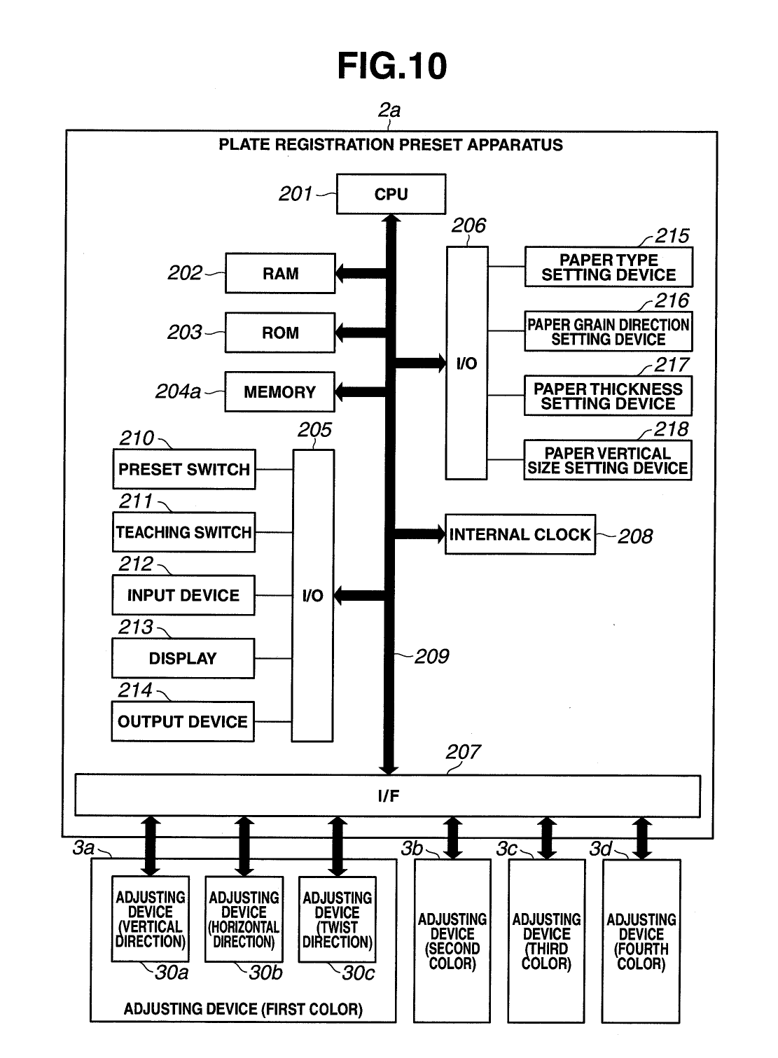

The plate registration preset apparatus 2a includes a CPU (Central Processing Unit) 201, a RAM (Random Access Memory) 202, a ROM (Read Only Memory) 203, a memory 204a, input/output interfaces (I/O, I/F) 205 to 207, and an internal clock 208 with a time measurement function, as shown in FIG. 10. These elements 201 to 208 are connected to each other via a communication line 209 such as a bus.

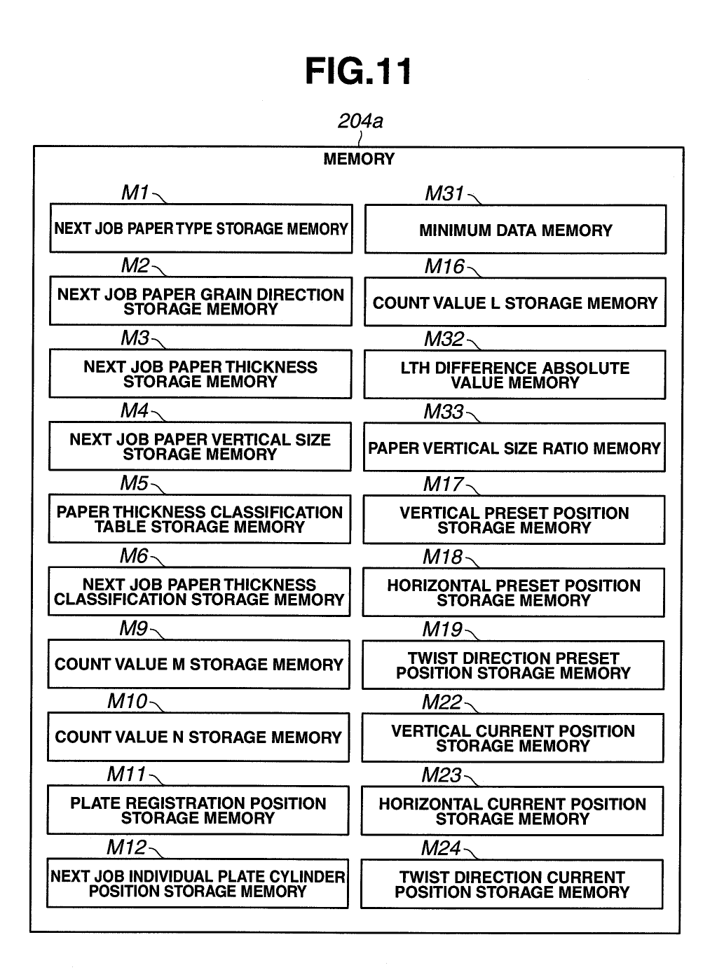

The memory 204a includes memories M1 to M6, M9 to M12, M16 to M19, M22 to M24, and M31 to M33, as shown in FIG. 11. Of these memories, the minimum difference data storage memory M31 stores minimum difference data. The Lth difference absolute value storage memory M32 stores the absolute value of the Lth difference. The paper vertical size ratio storage memory M33 stores the vertical size ratio of a printing sheet. Also, the plate registration position storage memory M11 stores pieces of information concerning the address location, the type, grain direction, paper thickness classification, and paper size of a printing sheet, and the positions of the plate cylinders of the first to fourth colors in the vertical, horizontal, and twist directions in association with each other, as shown in, for example, Table 4.

TABLE 4
Data Structure of Plate Registration Position Storage Memory

| | | | | | | | Position of | | |
|---|---|---|---|---|---|---|---|---|---|
| | | | | | Vertical | Horizontal | Plate | Vertical | Horizontal |
| | | | | | Position of | Position of | Cylinder of | Position of | Position of |
| | | | Paper | | Plate | Plate | First Color | Plate | Plate |
| Address | Paper | Paper Grain | Thickness | Paper | Cylinder of | Cylinder of | in Twist | Cylinder of | Cylinder of |
| Location | Type | Direction | Classification | Size | First Color | First Color | Direction | Second Color | Second Color |
| 1 | Coated | Vertical | 1 | 420 | 0.00 | 0.00 | 0.00 | 0.01 | 0.00 |
| | Paper | | | | | | | | |
| 2 | High- | Horizontal | 2 | 297 | 0.00 | 0.00 | 0.00 | 0.02 | 0.00 |
| | quality | | | | | | | | |
| | Paper | | | | | | | | |
| 3 | Matte | Vertical | 3 | 420 | 0.00 | 0.00 | 0.00 | 0.02 | 0.01 |
| | Paper | | | | | | | | |
| 4 | Specialty | None | 2 | 594 | 0.00 | 0.00 | 0.00 | 0.02 | −0.01 |
| | Paper | | | | | | | | |
| 5 | Coated | Horizontal | 1 | 210 | 0.00 | 0.00 | 0.00 | 0.02 | 0.00 |
| | Paper | | | | | | | | |
| 6 | Coated | Vertical | 1 | 297 | 0.00 | 0.00 | 0.00 | 0.01 | 0.01 |
| | Paper | | | | | | | | |

| | Position of | | | Position of | | | Position of |
|---|---|---|---|---|---|---|---|
| | Plate | Vertical | Horizontal | Plate | Vertical | Horizontal | Plate |
| | Cylinder of | Position of | Position of | Cylinder of | Position of | Position of | Cylinder of |
| | Second Color | Plate | Plate | Third Color | Plate | Plate | Fourth Color |
| Address | in Twist | Cylinder of | Cylinder of | in Twist | Cylinder of | Cylinder of | in Twist |
| Location | Direction | Third Color | Third Color | Direction | Fourth Color | Fourth Color | Direction |
| 1 | 0.00 | 0.02 | 0.00 | 0.00 | 0.03 | 0.00 | 0.00 |
| 2 | 0.00 | 0.04 | 0.00 | 0.00 | 0.06 | 0.00 | 0.00 |
| 3 | 0.01 | 0.04 | 0.01 | 0.01 | 0.06 | 0.01 | 0.01 |
| 4 | −0.01 | 0.04 | 0.01 | 0.01 | 0.06 | 0.01 | −0.01 |
| 5 | 0.00 | 0.04 | 0.00 | 0.00 | 0.06 | 0.00 | 0.00 |
| 6 | 0.01 | 0.02 | 0.01 | 0.01 | 0.03 | 0.01 | 0.01 |

### 2.2 Schematic Operation of Printing System

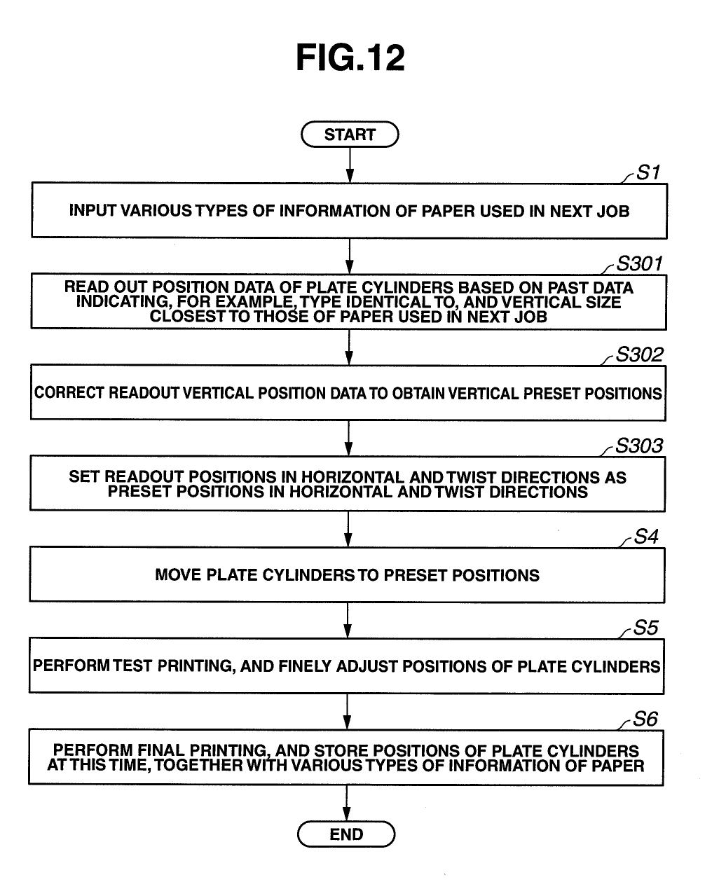

The schematic operation of a printing system equipped with the plate registration preset apparatus 2a will be described next with reference to FIG. 12. Note that the same reference numerals as in FIG. 6 of the first embodiment denote the same operations in FIG. 12, and a description thereof will be omitted as needed.

First, the operator inputs, to the plate registration preset apparatus 2a, various types of information of a printing sheet used in the next job, that is, the type, grain direction, paper thickness, and vertical size of a printing sheet (step S1).

Upon receiving the various types of information of a printing sheet, the plate registration preset apparatus 2a reads out the positions of the plate cylinders 11a to 11d in the vertical, horizontal, and twist directions, which are stored in the past, for a printing sheet indicating a type, paper grain direction, and paper thickness identical to, and a vertical size closest to those of a printing sheet used in the next job (step S301).

Upon reading out the past data indicating a closest vertical size of a printing sheet, the plate registration preset apparatus 2a corrects the readout vertical positions of the plate cylinders 11a to 11d to obtain the vertical preset positions of the plate cylinders 11a to 11d, based on the vertical size of a printing sheet used in the next job (step S302). The length of vertical stretching of a printing sheet in printing is proportional to the length of a printing sheet. Hence, in this embodiment, the ratio in vertical size between a printing sheet used in the next job, and another printing sheet having a size closest to that of the former printing sheet is calculated, and the vertical positions of the plate cylinders 11a to 11d when a printing sheet having a closest size are corrected using this ratio to obtain the vertical preset positions.

Upon obtaining the vertical preset positions of the plate cylinders 11a to 11d, the plate registration preset apparatus 2a sends the readout positions of the plate cylinders 11a to 11d in the horizontal and twist directions to the plate cylinder position adjusting devices 3a to 3d of the first to fourth colors as preset positions, together with the vertical preset positions of the plate cylinders 11a to 11d (step S303).

Upon receiving the preset positions from the plate registration preset apparatus 2a, the plate cylinder position adjusting devices 3a to 3d of the first to fourth colors move the plate cylinders 11a to 11d to the positions in the vertical, horizontal, and twist directions to the received preset positions (step S4). Then, the test printing operation of the printing product of the next job is performed, and the plate cylinder position adjusting devices 3a to 3d of the first to fourth colors finely adjust the positions of the plate cylinders 11a to 11d in the vertical, horizontal, and twist directions based on a necessary operator's operation input (step S5). When the final printing operation of the printing product of the next job is performed, the plate registration preset apparatus 2a stores the positions of the plate cylinders 11a to 11d in the vertical, horizontal, and twist directions in this final printing operation, together with the type, grain direction, paper thickness, and vertical size of a printing sheet at that time (step S6).

With this arrangement, even if a printing sheet having an identical vertical size is absent in the past data, the vertical positions of the plate cylinders 11a to 11d are corrected based on past data indicating a closest vertical size. For this reason, the operator need not adjust the positions of the plate cylinders 11a to 11d from the initial state, so the burden required for adjustment can be relieved.

### 2.3 Detailed Operation of Plate Registration Preset Apparatus

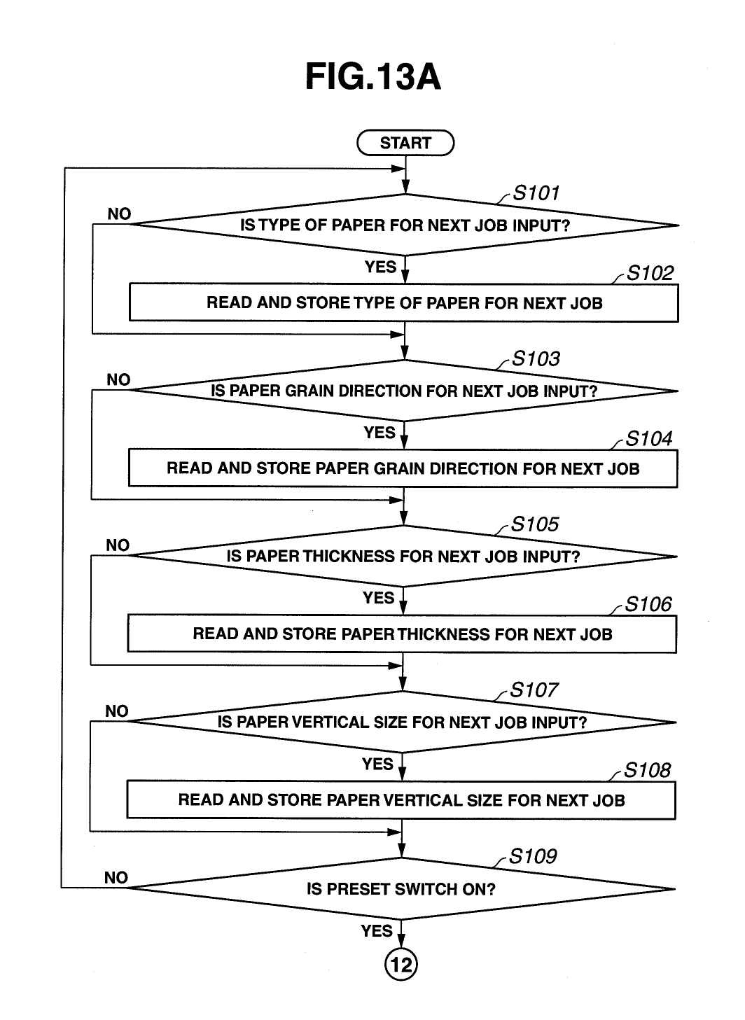

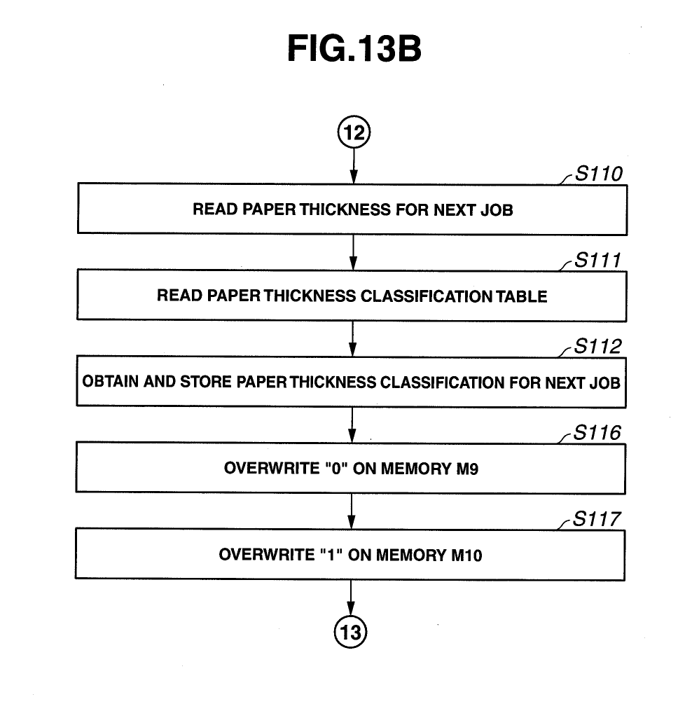

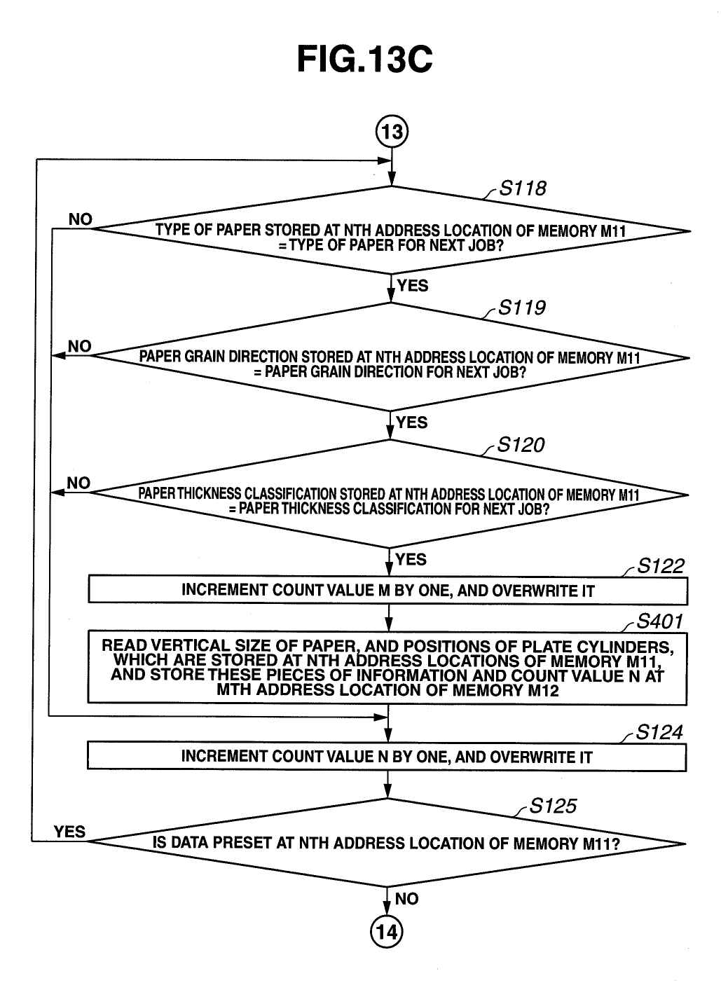

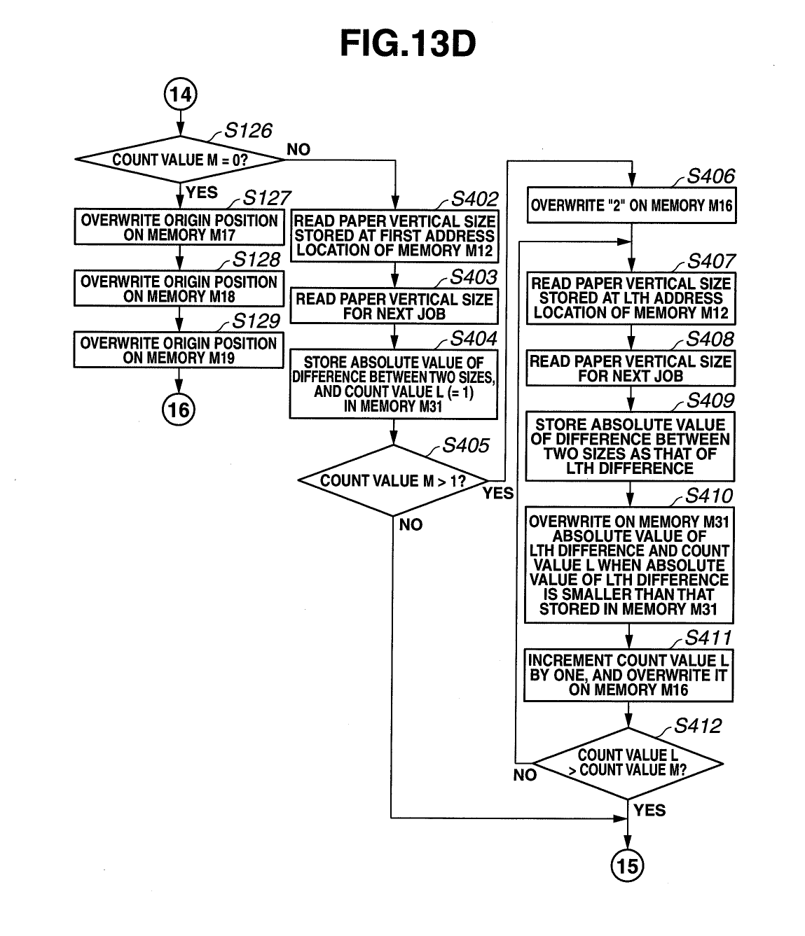

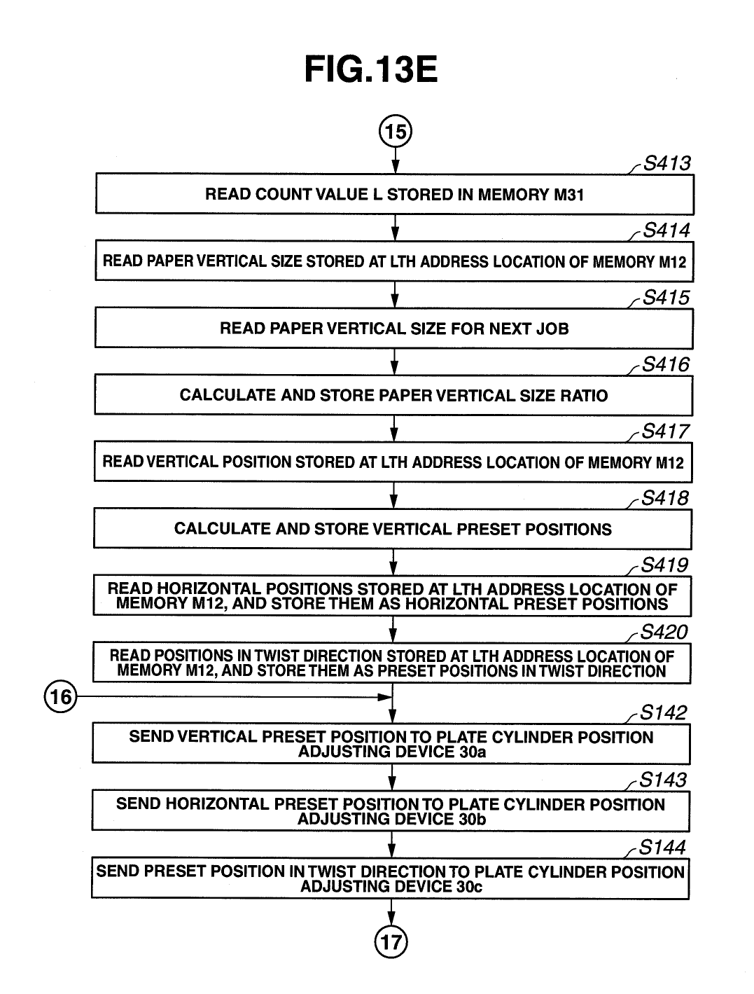

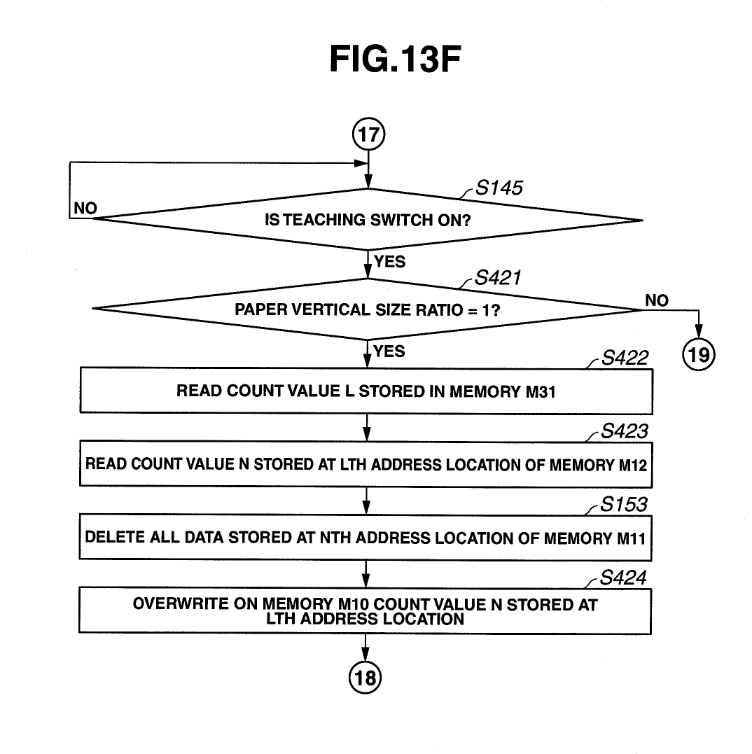

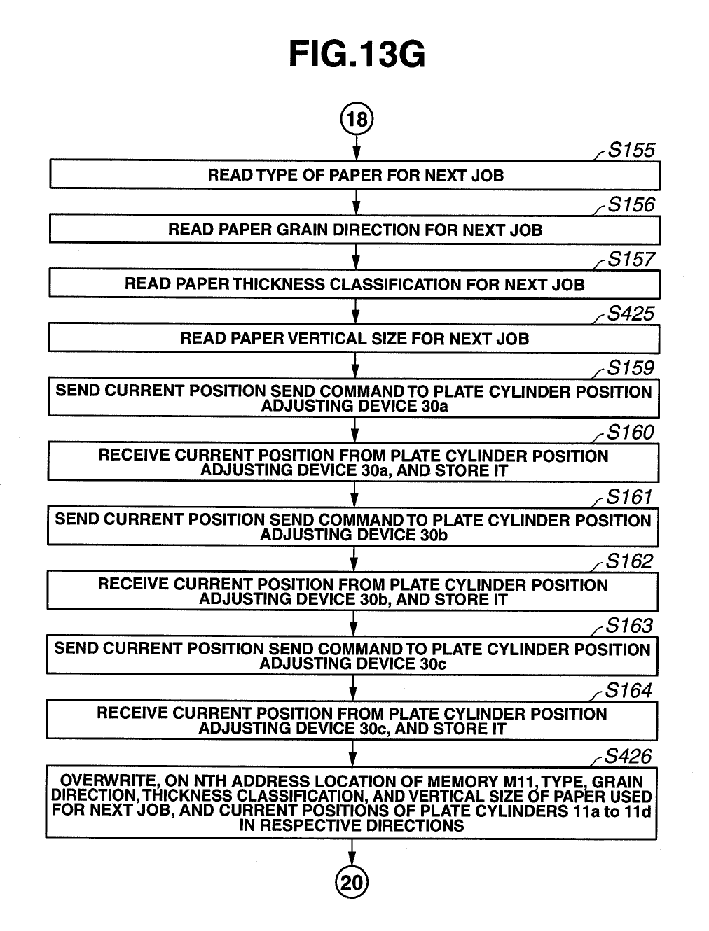

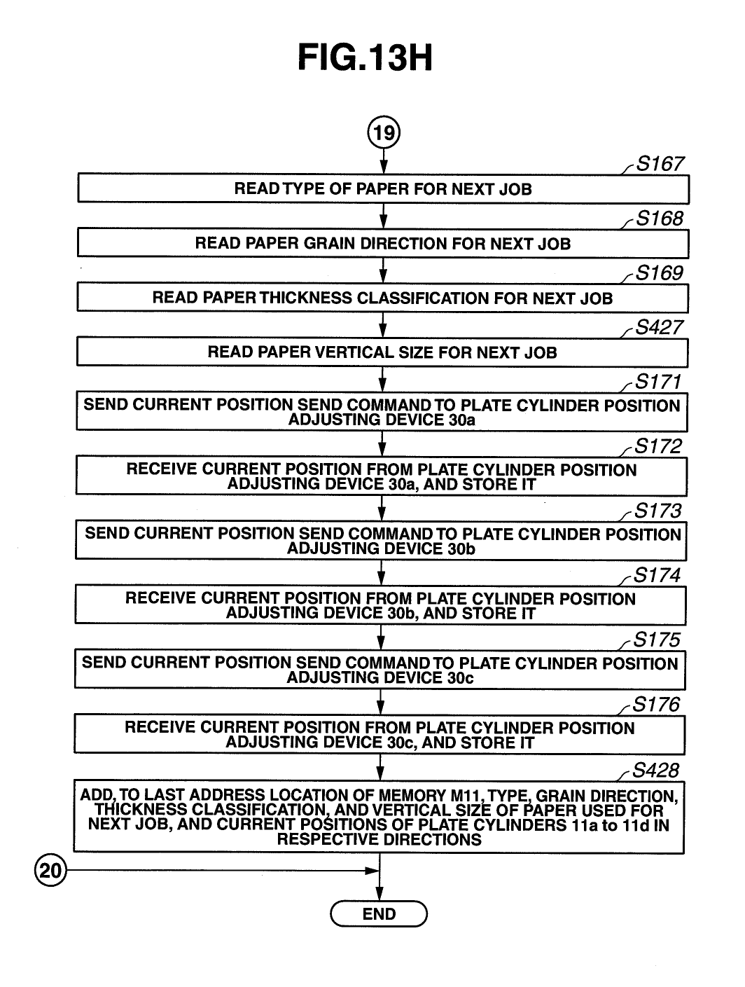

The detailed operation of the plate registration preset apparatus 2a will be described next with reference to FIGS. 13A to 13H. Note that the same reference numerals as in FIGS. 7A to 7H of the first embodiment denote the same operations in FIGS. 13A to 13H, and a description thereof will be omitted as needed.

First, as shown in FIGS. 13A and 13B, when the processes in steps S101 to S112 described in the first embodiment are executed, the CPU 201 overwrites the count value M in the memory M9 with M=0 (step S116), and overwrites the count value N in the memory M10 with N=1 (step S117).

Then, the CPU 201 extracts from the memory M11 a printing sheet having a type, grain direction, and paper thickness classification identical to those of a printing sheet used in the next job, as shown in FIG. 13C.

More specifically, the processes in steps S118 to S120 described in the first embodiment are executed, and, if all of the type, grain direction, and paper thickness classification of a printing sheet are identical (YES in steps S118 to S120), the CPU 201 increments the count value M in the memory M9 by one, and overwrites it on the memory M9 (step S122). The CPU 201 stores, at the Mth address location of the memory M12, the vertical size of a printing sheet, the values of the positions, in the vertical, horizontal, and twist directions, of the plate cylinders 11a to 11d of the first to fourth colors, and the count value N, which are stored at the Nth address locations in the memory M11 (step S401). The CPU 201 increments the count value N in the memory M10 by one, and overwrites it on the memory M10 (step S124). Then, the CPU 201 determines whether data is present at the Nth address location of the memory M11 (step S125).

On the other hand, if one of the type, grain direction, and paper thickness classification of a printing sheet is different (NO in one of steps S118 to S120), the CPU 201 executes processes in steps S124 and S125.

If data is present at the Nth address location of the memory M11 (YES in step S125), the CPU 201 returns the process to step S118.

On the other hand, if data is absent at the Nth address location of the memory M11 (NO in step S125), the CPU 201 executes a preliminary process of registering preset positions, as shown in FIG. 13D.

More specifically, first, the CPU 201 confirms whether the count value M in the memory M9 is M=0 (step S126).

If the count value M is M=0 (YES in step S126), this means that data of a printing sheet having an identical type, paper grain direction, and paper thickness has not been stored in the memory M11. Therefore, the CPU 201 overwrites on the memories M17 to M19 the origin positions of the plate cylinders 11a to 11d in the respective directions (vertical, horizontal, and twist directions) (steps S127-S129), and advances the process to step S142 (to be described later).

On the other hand, if the count value M is M≠0 (NO in step S126), this means that data of a printing sheet having an identical type, paper grain direction, and paper thickness has been stored in the memory M11. Therefore, the CPU 201 reads the vertical size of a printing sheet stored at the first address location of the memory M12 (step S402). The CPU 201 also reads from the memory M4 the vertical size of a printing sheet used in the next job (step S403). Then, the CPU 201 obtains the absolute value of the difference between the vertical size of a printing sheet stored at the first address location of the memory M12, and that of a printing sheet used in the next job, and stores it in the memory M31 in association with the count value L (=1) (step S404).

The CPU 201 confirms whether the count value M in the memory M9 is larger than 1 (step S405).

If the count value M in the memory M9 is 1 or less (NO in step S405), this means that only one data is included in the memory M12, so the CPU 201 advances the process to step S413 (to be described later).

On the other hand, if the count value M in the memory M9 is larger than 1 (YES in step S405), this means that two or more data are included in the memory M12, so the CPU 201 overwrites the count value L in the memory M16 with “2” (step S406).

The CPU 201 reads from the memory M12 the vertical size of a printing sheet stored at its Lth address location (step S407), and reads the vertical size of a printing sheet used in the next job from the memory M4 (step S408). Then, the CPU 201 obtains the absolute value of the difference between the vertical size of a printing sheet stored at the Lth address location of the memory M12, and that of a printing sheet used in the next job, and stores it in the memory M32 as an Lth absolute value in association with the count value L (step S409). If the Lth absolute value stored in the memory M32 is determined to be smaller than the absolute value of the difference stored in the memory M31 in their comparison, the Lth absolute value and count value L are overwritten on the memory M31 (step S410). Note that when the absolute value of the difference stored in the memory M31 is smaller, neither the Lth absolute value nor the count value L is overwritten on the memory M31.

The CPU 201 increments the count value L in the memory M16 by one, and overwrites it on the memory M16 (step S411). The CPU 201 confirms whether the count value L is larger than the count value M in the memory M9 (step S412).

If the count value L is equal to or smaller than the count value M (NO in step S412), this means that data which has not yet been compared with the absolute value of the difference stored in the memory M31 is present in the memory M12, so the CPU 201 returns the process to step S407.

On the other hand, if the count value L is larger than the count value M (YES in step S412), a comparison between all data in the memory M12 and the absolute value of the difference stored in the memory M31 has ended. Therefore, the CPU 201 registers preset positions, as shown in FIG. 13E.

More specifically, the CPU 201 reads the count value L stored in the memory M31 (step S413), and reads the vertical size of a printing sheet stored at the Lth address location of the memory M12 based on the count value L (step S414). The CPU 201 also reads from the memory M4 the vertical size of a printing sheet used in the next job (step S415). Then, the CPU 201 divides the vertical size of a printing sheet used in the next job by that of a printing sheet stored at the Lth address location to calculate the vertical ratio of a printing sheet, and store the calculation result in the memory M33 (step S416).

Upon calculating the vertical ratio of a printing sheet, the CPU 201 reads the vertical positions of the plate cylinders 11a to 11d stored at the Lth address location of the memory M12 (step S417). Then, the CPU 201 multiplies these positions by the vertical ratio of a printing sheet stored in the memory M33 to calculate the vertical preset positions of the plate cylinders 11a to 11d, and store the calculation result in the memory M17 (step S418).

The CPU 201 also reads the horizontal positions of the plate cylinders 11a to 11d stored at the Lth address location of the memory M12, and stores these positions in the memory M18 as horizontal preset positions (step S419). Similarly, the CPU 201 reads the positions of the plate cylinders 11a to 11d in the twist direction stored at the Lth address location of the memory M12, and stores these positions in the memory M19 as preset positions in the twist direction (step S420).

Upon storing the preset positions in the memories M17 to M19, the CPU 201 sends the preset positions in the respective directions stored in the memories M17 to M19 to a vertical plate cylinder position adjusting device 30a, horizontal plate cylinder position adjusting device 30b, or twist direction plate cylinder position adjusting device 30c of each of the plate cylinder position adjusting devices 3a to 3d of the first to fourth colors (steps S142-S144). The plate cylinder position adjusting devices 3a to 3d of the first to fourth colors move the plate cylinders 11a to 11d to the preset positions in the vertical, horizontal, and twist directions received from the plate registration preset apparatus 2a. For this reason, the operator need not adjust the positions of the plate cylinders from the initial state, so the burden required for adjustment can be relieved.

When the preset positions are calculated using the above-mentioned method, the operator turns on a teaching switch 211 to register them. As shown in FIG. 13F, if the CPU 201 confirms that the teaching switch 211 is ON (YES in step S145), it confirms whether the vertical size ratio of a printing sheet in the memory M33 is 1 (step S421). Note that when the respective conditions of a printing sheet and the positions of the plate cylinders 11a to 11d are stored while printing is actually in progress or after the end of printing, the “next job” should be replaced with the “current job”. However, in this case, since the conditions of a printing sheet and the positions of the plate cylinders 11a to 11d at that time are stored in the memory M11 before final printing, a description will be given directly using the expression “next job”.

If the vertical size ratio is 1 (YES in step S421), this means that the vertical size of a printing sheet having a minimum absolute value of the difference in vertical size stored in the memory M31 is equal to that of a printing sheet used in the next job. Therefore, the CPU 201 replaces the data of a printing sheet having a minimum difference stored in the memory M11 with that of a printing sheet used in the next job.

More specifically, the CPU 201 reads the count value L stored in the memory M31 (step S422), reads the count value N stored at the Lth address location of the memory M12 (step S423), and deletes all data stored at the Nth address location of the memory M11 (step S153). The CPU 201 overwrites on the memory M10 the count value N stored at the Lth address location of the memory M12 to register the preset positions instead of the deleted data (step S424).

As shown in FIG. 13G, the CPU 201 also reads the type, grain direction, paper thickness classification, and vertical size of a printing sheet used in the next job from the memories N1, M2, M6, and M4, respectively (steps S155-S157 & S425). The CPU 201 sends commands to send the current positions of the plate cylinders 11a to 11d in the respective directions to the vertical plate cylinder position adjusting device 30a, horizontal plate cylinder position adjusting device 30b, and twist direction plate cylinder position adjusting device 30c of each of the plate cylinder position adjusting devices 3a to 3d of the first to fourth colors (steps S159, S161, & S163). Upon receiving the current positions, in the respective directions, of the plate cylinders 11a to 11d sent from the devices 30a to 30c in response to these commands, the CPU 201 stores the received current positions in the respective directions in the memories M22 to M24 (steps S160, S162, & S164). Then, the CPU 201 overwrites on the Nth address location of the memory M11 the type, grain direction, paper thickness classification, and paper vertical size of a printing sheet used in the next job, and the current positions of the plate cylinders 11a to 11d of the first to fourth colors in the vertical, horizontal, and twist directions, which are obtained in the above-mentioned steps S155 to S157, S425, S160, S162, and S164 (step S426). With this operation, the data indicating a minimum difference in vertical size from a printing sheet used in the next job, which is stored in the memory M11, as shown in Table 4, is rewritten with most recent preset positions by the plate registration preset apparatus 2a.

On the other hand, if the vertical size ratio is not 1 (NO in step S421), this means that the vertical size of a printing sheet having a minimum absolute value of the difference in vertical size stored in the memory M31 is different from that of a printing sheet used in the next job. Therefore, the CPU 201 additionally registers the data of a printing sheet having a minimum difference.

More specifically, as shown in FIG. 13H, the CPU 201 reads from the memories M1, M2, M6, and M4 the type, grain direction, paper thickness classification, and paper vertical size of a printing sheet used in the next job (steps S167-S169 & S427). The CPU 201 sends commands to send the current positions of the plate cylinders 11a to 11d in the respective directions to the vertical plate cylinder position adjusting device 30a, horizontal plate cylinder position adjusting device 30b, and twist direction plate cylinder position adjusting device 30c of each of the plate cylinder position adjusting devices 3a to 3d of the first to fourth colors (steps S171, S173, & S175). Upon receiving the current positions, in the respective directions, of the plate cylinders 11a to 11d sent from the devices 30a to 30c in response to these commands, the CPU 201 stores the received current positions in the respective directions in the memories M22 to M24 (steps S172, S174, & S176). Then, the CPU 201 adds, to the last address location of the memory M11, the type, grain direction, paper thickness classification, and paper vertical size of a printing sheet used in the next job, and the current positions of the plate cylinders 11a to 11d of the first to fourth colors in the vertical, horizontal, and twist directions, which are obtained in the above-mentioned steps S167 to S169, S427, S172, S174, and S176 (step S428). As a result, each data associated with the plate registration position, as shown in Table 4, is stored in the memory M11. At this time, most recent preset positions are stored in the memory M11 by the plate registration preset apparatus 2a.

### 2.4 Effect of Second Embodiment

As described above, according to this embodiment, the vertical positions of the plate cylinders 11a to 11d stored in advance are corrected in accordance with the vertical size of a printing sheet to move the plate cylinders 11a to 11d to the corrected positions. With this operation, even if the final printing operation of a printing sheet having an identical vertical size is not performed in the past, the operator need not adjust the positions of the plate cylinders 11a to 11d from the initial state where registration is not done at all, so his or her burden can be relieved.

### 3. Other Embodiments

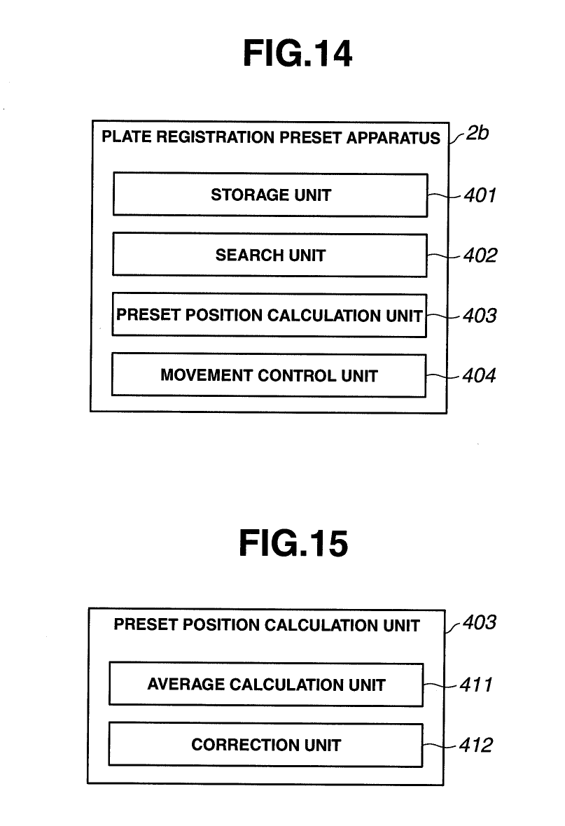

The plate registration preset apparatuses 2 and 2a used in the above-mentioned first and second embodiments can be represented by block diagrams as shown in FIGS. 14 and 15.

A plate registration preset apparatus 2b shown in FIG. 14 includes a storage unit 401, search unit 402, preset position calculation unit 403, and movement control unit 404.

The storage unit 401 stores the conditions of a sheet at the time of final printing, and the positions of plate cylinders 11a to 11d at that time in association with each other. The sheet includes not only paper but also, for example, a plastic sheet to be printed. The conditions of a sheet mean pieces of information associated with a sheet, including the type, grain direction, thickness, and size of the sheet. The plate cylinders 11a to 11d serve to print images of different colors. In other words, the plate cylinders 11a to 11d serve to print images of first to fourth colors. Note that at least one of the plate cylinders 11a to 11d may be stored in association with the conditions of a sheet. The storage unit 401 corresponds to the memory 204 in the first embodiment, and the memory 204a in the second embodiment.

The search unit 402 searches the information stored in the storage unit 401 for a sheet with conditions, at least some of which are common to those of the sheet to be printed. The search unit 402 may search for a sheet with all conditions common to those of the sheet to be printed, as in the first embodiment, or search for a sheet with conditions, at least some of which are common to those of the sheet to be printed, as in the second embodiment. The search unit 402 executes, for example, the processes in steps S2 and S116 to S125 of the first embodiment, and those in steps S301, S116 to S120, S122, S124, S125, and S401 of the second embodiment.

The preset position calculation unit 403 reads out from the storage unit 401 the positions of the plate cylinders 11a to 11d corresponding to the conditions of a sheet found by the search unit 402, and calculates the preset positions of the plate cylinders 11a to 11d based on the readout positions. The preset position calculation unit 403 executes, for example, the processes in steps S3 and S126 to S141 of the first embodiment, and those in steps S302, S126 to S129, and S402 to S420 of the second embodiment.

The preset position calculation unit 403 includes an average calculation unit 411 and correction unit 412, as shown in FIG. 15.

The average calculation unit 411 stores in the storage unit 401a plurality of sheets with conditions common to those of the sheet to be printed. When a plurality of sheets are found by the search unit 402, the average calculation unit 411 averages a plurality of position data corresponding to the plurality of sheets, respectively, to calculate preset positions. The average calculation unit 411 executes, for example, the processes in steps S3 and S130 to S141 of the first embodiment.

When a sheet with conditions, some of which are common to those of the sheet to be printed, is stored in the storage unit 401, the correction unit 412 reads out and corrects the position data corresponding to the stored sheet to calculate preset positions. At this time, the readout position data is corrected using the conditions of the sheet to be printed, which are different from those of the sheet stored in the storage unit 401. In the second embodiment, when the size of the sheet to be printed is different from that of the stored sheet, the stored position data is corrected in accordance with the size of the sheet to be printed. More specifically, the correction unit 412 executes the processes in steps S302 and S402 to S418.

Note that when one sheet with all conditions common to those of the sheet to be printed is stored in the storage unit 401, the preset position calculation unit 403 directly sets as preset positions the positions stored in association with the stored sheet. For this reason, the preset position calculation unit 403 is not an indispensable element of the present invention.

The movement control unit 404 controls to move the plate cylinders 11a to 11d to the preset positions. The movement control unit 404 executes, for example, the processes in steps S4 and S142 to S144. Note that the movement control unit 404 controls only a plate cylinder, stored in the storage unit 401, of the plate cylinders 11a to 11d.

### 4. Effect of Embodiments

According to the embodiments of the present invention, when the printing press 1 prints on a printing sheet, it is determined whether the type of this printing sheet is identical to that of printing sheet at the time of final printing, which is stored in the memory 204 or 204a. If these two types are identical, at least one of the plurality of plate cylinders 11a to 11d is moved to the position stored in the memory 204 or 204a in association with the printing sheet at the time of final printing. Note that the memory 204 or 204a may store a plurality of types of printing sheets at the time of final printing, and a plurality of sets of the position of at least one of the plurality of plate cylinders 11a to 11d.

If printing is performed using a printing sheet having a grain direction identical to that of a printing sheet having undergone final printing in the past, at least one of the plurality of plate cylinders 11a to 11d is moved to the position where final printing has been performed in the past. However, if printing is performed using a printing sheet having a thickness identical to that of a printing sheet having undergone final printing in the past, at least one of the plurality of plate cylinders 11a to 11d is moved to the position where final printing has been performed in the past. If printing is performed using a printing sheet having a size identical to that of a printing sheet having undergone final printing in the past, at least one of the plurality of plate cylinders 11a to 11d is moved to the position where final printing has been performed. In contrast, if printing is performed using a printing sheet having a size different from that of a printing sheet having undergone final printing in the past, at least one of the plurality of plate cylinders 11a to 11d is moved to a position obtained by correcting that, where final printing has been performed, in accordance with the size.

Note that in the above-mentioned first and second embodiments, plate cylinders whose preset positions are generated or whose positions at the time of final printing are stored, and the directions of the plate cylinders need not be all of the plate cylinders 11a to 11d of the first to fourth colors, and the three directions (vertical, horizontal, and twist directions), and may be freely set as needed.

The present invention is applicable to various apparatuses which use plate cylinders, such as an offset printing press.

What is claimed is:

1. A registration method for a printing press, comprising the steps of:
storing conditions of a sheet, and a position of at least one plate cylinder of a plurality of plate cylinders at a time of final printing in a storage unit in association with each other, the plurality of plate cylinders being configured to print images of different colors;
in printing on a sheet to be printed, searching the information stored in the storage unit for a sheet with conditions, at least some of which are common to conditions of the sheet to be printed; and
moving the at least one plate cylinder to the position associated with the found conditions of the sheet.

2. A method according to claim 1, wherein the conditions of the sheet include a type of the sheet.

3. A method according to claim 1, wherein the conditions of the sheet include a grain direction of the sheet.

4. A method according to claim 1, wherein the conditions of the sheet include a thickness of the sheet.

5. A method according to claim 1, wherein the conditions of the sheet include a size of the sheet.

6. A method according to claim 5, further comprising the step of:
correcting the position, stored in the storage unit, in accordance with the size of the sheet to be printed,
the moving step including the step of moving the at least one plate cylinder to the corrected position.

7. A registration apparatus for a printing press, comprising:
a storage unit which stores conditions of a sheet, and a position of at least one plate cylinder of a plurality of plate cylinders at a time of final printing, the plurality of plate cylinders being configured to print images of different colors;
a search unit which, in printing on a sheet to be printed, searches the information stored in the storage unit for a sheet with conditions, at least some of which are common to conditions of the sheet to be printed; and
a movement control unit which controls to move the at least one plate cylinder to the position stored in the storage unit in association with the found conditions of the sheet.

8. An apparatus according to claim 7, wherein the conditions of the sheet include a type of the sheet.

9. An apparatus according to claim 7, wherein the conditions of the sheet include a grain direction of the sheet.

10. An apparatus according to claim 7, wherein the conditions of the sheet include a thickness of the sheet.

11. An apparatus according to claim 7, wherein the conditions of the sheet include a size of the sheet.

12. An apparatus according to claim 11, further comprising:
a correction unit which corrects the position, stored in the storage unit, in accordance with the size of the sheet to be printed,
wherein the movement control unit is configured to move the at least one plate cylinder to the position corrected by the correction unit.
